(19) United States
(12) Patent Application Publication
(10) Pub. No.: US 2014/0156721 A1
(43) Pub. Date: Jun. 5, 2014

(54) INFORMATION PROCESSING SYSTEM AND COMMUNICATION TERMINAL

(71) Applicant: FUJITSU LIMITED, Kawasaki-shi (JP)

(72) Inventors: Hideto Kihara, Kawasaki (JP); Junichi Yura, Yokohama (JP); Takashi Ohno, Kobe (JP)

(73) Assignee: FUJITSU LIMITED, Kawasaki-shi (JP)

(21) Appl. No.: 14/095,128

(22) Filed: Dec. 3, 2013

(30) Foreign Application Priority Data
Dec. 5, 2012 (JP) 2012-266634

(51) Int. Cl. H04L 29/08

(52) U.S. Cl. CPC H04L 67/10
USPC 709/202

(57) ABSTRACT

An information processing system includes a processor configured to predict an in-use situation of a communication terminal at a time of use of an application executed on the communication terminal, and prepare adjusted content of at least a portion of the application based on an in-use situation of the communication terminal as predicted by the circuitry.

### CROSS-REFERENCE TO RELATED APPLICATION

This application is based upon and claims the benefit of priority of the prior Japanese Patent Application No. 2012-266634, filed on Dec. 5, 2012, the entire contents of which are incorporated herein by reference.

### FIELD

The embodiment discussed herein is related to an information processing system and a communication terminal.

### BACKGROUND

There has been proposed a computing system configured to distribute an application (hereinafter, also referred to as “app”) to be executed on a communication terminal such as a smartphone, tablet, or the like from a server at predetermined timing to execute this. For example, there has been proposed a humancentric computing (hereinafter, referred to as “HCC”) system or the like configured to realize comfortable usage of an app in accordance with a user situation (position or the like). The HCC system is a system configured to push-distribute a prepared app to a communication terminal when going into a predetermined user situation (position).

However, an HCC system according to the related art only pushes a terminal app which has already been developed, in accordance with the user situation at the time of pushing, and accordingly, app developers have to prepare separate apps for each little difference in situation. Therefore, as a related art for adjusting display contents or access propriety in accordance with a user situation (terminal position, action schedule), there is a technique for adjusting display contents or access propriety at the time of pushing, at the time of use, and at the time of change in situations (e.g., see Japanese Laid-open Patent Publication Nos. 2002-259252, 2011-186579, and 2005-63292).

Also, there has been a problem in that, after an app is pushed to a communication terminal, the app is not used and abandoned. Therefore, there has been a technique for adjusting app contents in accordance with operation situation (unoperated period) of the application after pushing (e.g., see Japanese Laid-open Patent Publication No. 2003-167833).

### SUMMARY

According to an aspect of the invention, an information processing system includes a processor configured to predict an in-use situation of a communication terminal at a time of use of an application executed on the communication terminal, and prepare adjusted content of at least a portion of the application based on an in-use situation of the communication terminal as predicted by the circuitry.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a schematic configuration example in an application providing system;

FIG. 2 is a diagram illustrating an example of a function configuration in the application providing system;

FIG. 3 is a diagram illustrating an example of a hardware configuration in the application providing system;

FIG. 4 is a diagram illustrating an example of a function configuration in a communication terminal;

FIG. 5 is a diagram illustrating an example of a hardware configuration in the communication terminal;

FIGS. 6A to 6D are first diagrams illustrating a data example to be stored in an application providing server;

FIGS. 7A and 7B are second diagrams illustrating a data example to be stored in the application providing server;

FIGS. 8A to 8E are diagrams illustrating a data example to be stored in a communication terminal;

FIG. 9 is a flowchart illustrating an example of first-time terminal app generation processing;

FIG. 10 is a flowchart illustrating an example of readjustment processing at the time of change in a user situation;

FIG. 11 is a flowchart illustrating an example of prediction processing of a predicted in-use situation;

FIG. 12 is a flowchart illustrating an example of updating processing of an app in-use situation correlation DB;

FIG. 13 is a flowchart illustrating an example of contents adjustment processing;

FIG. 14 is a first flowchart illustrating an example of readjustment necessity determination processing;

FIG. 15 is a second flowchart illustrating an example of readjustment necessity determination processing;

FIG. 16 is a first flowchart illustrating an example of updating processing of a user situation DB;

FIG. 17 is a second flowchart illustrating an example of updating processing of the user situation DB;

FIG. 18 is a flowchart illustrating an example of app operation situation updating processing; and

FIG. 19 is a diagram illustrating an example of an adjustment processing script.

### DESCRIPTION OF EMBODIMENT

According to the above related art, at the time of starting use of an app, the app of which the operation has been adjusted in accordance with the user situation or app operation situation at that time is not in an immediately usable state.

Hereinafter, an embodiment will be described with reference to the appended drawings.

Schematic Configuration Example of Application Providing System

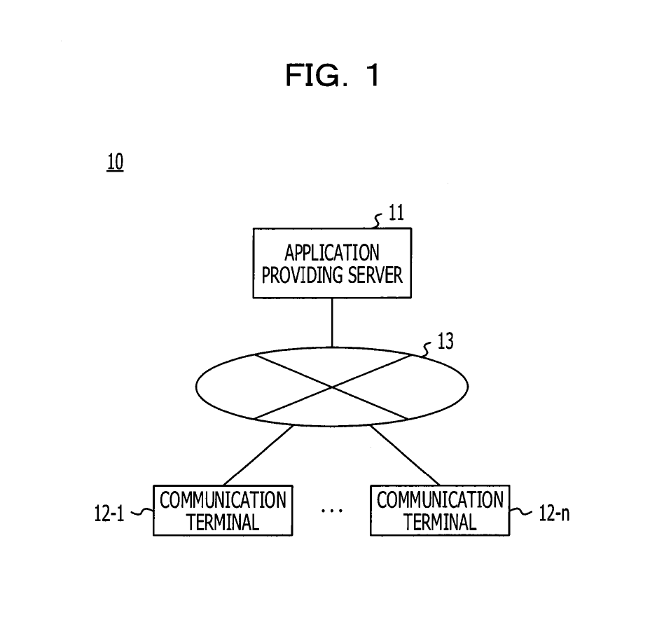

FIG. 1 is a diagram illustrating a schematic configuration example in an application providing system. An application providing system 10 illustrated in FIG. 1 includes an application providing server 11 as an example of an information processing apparatus, and communication terminals 12-1 to 12-n (hereinafter, collectively referred to as “communication terminal 12”). Also, the application providing server 11 and communication terminals 12 are connected by a communication network 13 in a state in which various types of information are receivable.

The application providing server 11 manages action history, operation history, current situation, future schedule, and so forth for each user who uses the communication terminal 12, and manages a schedule so as to provide a predetermined app (terminal app) at a predetermined time. Also, the application providing server 11 transmits to each of the terminals 12 an app adapted to a situation thereof via the communication network 13. Note that examples of the app include small increments of apps (micro apps) such as approval for each predetermined matter, questionnaire, business trip expenses, and so forth, but are not restricted to these, and include, for example, software such as mail software, word-processing software, spreadsheet software, and so forth. Also, the app is configured of, for example, a Hyper Text Markup Language (HTML)5 file, a JavaScript (registered trademark) file, or the like, but is not restricted to these.

Also, the application providing server 11 generates an app for a user who uses a communication terminal 12 based on a future user situation to be predicted beforehand, and distributes to the communication terminal 12. Also, the application providing server 11 monitors a user situation after transmission of an app, and performs readjustment such as regenerating or distributing an app according to a monitoring result and so forth. Note that, regarding readjustment of an app, difference data alone as to the app generated last time may be generated or distributed, for example. Also, regarding readjustment of an app, for example, an arrangement may be made wherein a terminal app is divided into an app serving as a significant portion and an app serving as an additional portion after distribution, and regeneration of an app according to necessity is performed on each thereof.

The application providing server 11 may be a general-purpose personal computer (PC) or server or the like, or may be a cloud system or the like. Also, the application providing server 11 may manage a schedule management server configured to manage a schedule or the like of a user who uses a communication terminal 12, a distribution rule execution server configured to perform execution of a distribution rule, and so forth as stand-alone configurations, for example.

The communication terminals 12 are mobile terminals to be used by the users, for example. For example, the communication terminals 12 execute various apps installed beforehand, or an app distributed from the application providing server 11 via the communication network 13. Position information and operation history as to the communication terminals 12, execution results of an app, and so forth are transmitted to the application providing server 11 via the communication network 13 at a predetermined timing, for example, such as periodically or at the time of starting a predetermined operation or execution, or the like.

The communication terminals 12 may be wireless communication terminals such as smartphones, tablet terminals, cellular phones, or the like, or may be notebook PCs, game machines, music players, or the like.

Examples of the communication network 13 include the Internet, and a local area network (LAN). The communication network 13 may be a cable or wireless, or a combination of these, for example.

Next, description will specifically be made regarding the configurations between the application providing server 11 and communication terminals 12 in the application providing system 10 as described above.

Function Configuration Example of Application Providing Server 11

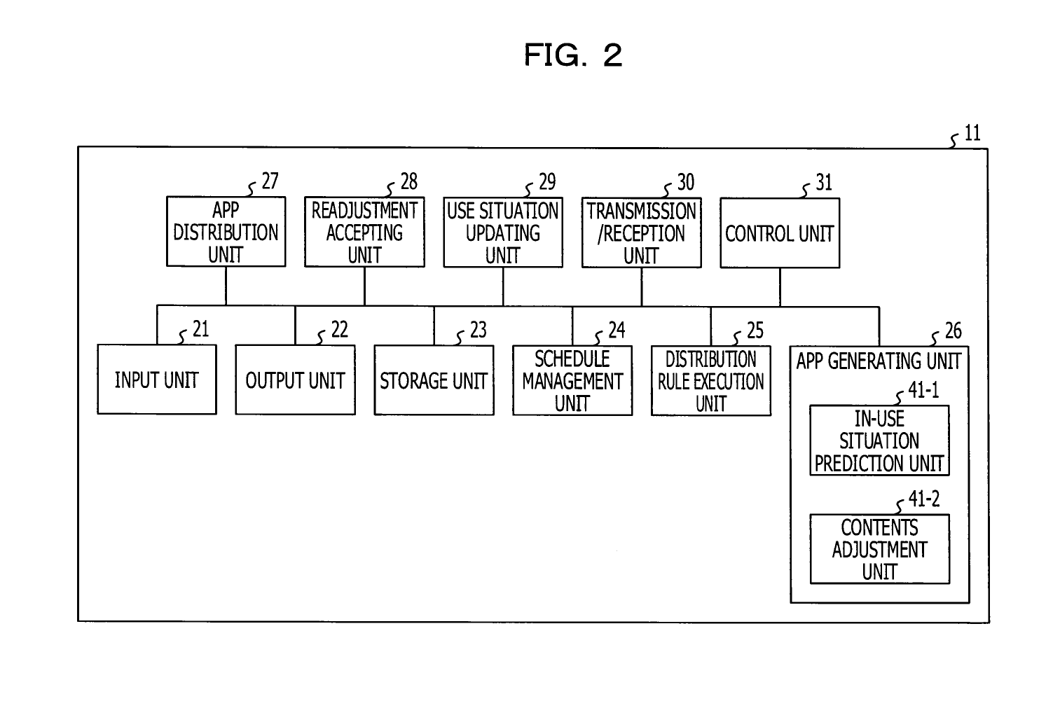

FIG. 2 is a diagram illustrating an example of a function configuration in the application providing server. The application providing server 11 in FIG. 2 includes an input unit 21, an output unit 22, a storage unit 23, a schedule management unit 24, a distribution rule execution unit 25, an app generating unit 26, an app distribution unit 27, a readjustment accepting unit 28, a use situation updating unit 29, a transmission/reception unit 30, and a control unit 31.

The input unit 21 accepts various types of input such as start or end of various instructions, or setting input or the like from a supervisor or the like who uses the application providing server 11. Specifically, the input unit 21 accepts each instruction, for example, such as a schedule management instruction, distribution rule execution instruction, or the like.

Input of information to be obtained by the input unit 21 may be, for example, input according to an input interface or the like such as a keyboard or mouse or the like, or may be input in a touch panel format using a screen. Further, the input unit 21 may include an audio input unit configured to input audio using a microphone or the like, for example.

The output unit 22 performs output such as contents input from the input unit 21, contents executed based on the input contents, and so forth. Note that, in the event of outputting the contents by screen display for example, the output unit 22 may include a display unit such as a display or monitor or the like, and in the event of outputting the contents by audio for example, may include an audio output unit such as a speaker or the like. Also, with regard to the input unit 21 and output unit 22, input and output may be an all-in-one type, for example, such as a touch panel or the like.

The storage unit 23 stores various types of information used for the present embodiment. Specifically, the storage unit 23 stores, for example, a template, a situation and adjustment correspondence database (hereinafter, database will be referred to as “DB”), a user situation DB, data in the middle of being input, a pushed app DB, use history, an app operation situation DB, and so forth as to a terminal app. Also, the storage unit 23 stores various types of information such as an app in-use situation correlation DB, an estimated situation DB, and so forth, but the various types of information are not restricted to these.

Also, the storage unit 23 stores setup information or the like for executing various types of processing that may be realized by application providing processing according to the present embodiment, or stores execution processes or results or the like of various types of processing. Also, the storage unit 23 may read out or write in stored various types of information at a predetermined timing as appropriate. Also, the storage unit 23 is an aggregation of various types of information such as described above, and may have a function serving as a database systematically configured so as to search for those information using, for example, a keyword or the like, and so as to extract those information. Note that the storage unit 23 is configured of, for example, a hard disk or memory or the like.

The schedule management unit 24 manages schedule contents previously set to each user who uses a communication terminal 12 for each user. The schedule contents are, for example, past schedules, future schedules, and so forth, but are not restricted to these.

Also, the schedule management unit 24 obtains position information of a communication terminal 12 at a predetermined timing such as periodically or at the time of moving equal to or longer than predetermined distance, or the like, and manages action history or current situation from the position information thereof. Also, the schedule management unit 24 manages operation history and so forth as to a communication terminal 12 of a user. Further, the schedule management unit 24 may also schedule timing to transmit a terminal app and other data to the communication terminal 12. Note that the functions at the schedule management unit 24 may be provided separately from the application providing server 11 as a schedule management server, for example.

The distribution rule execution unit 25 executes a predetermined distribution rule to determine whether to satisfy a condition to generate a terminal app. Also, the distribution rule execution unit 25 generates, in the event that the condition is satisfied, a predetermined terminal app using the app generating unit 26.

The distribution rule execution unit 25 determines whether a condition described in the distribution rule being executed is satisfied, based on operation history of each user, position information of a communication terminal 12 to be transmitted from the communication terminal 12 periodically or at the time of change in situations.

The app generating unit 26 generates, based on an app generation instruction from the distribution rule execution unit 25, a terminal app corresponding to the instruction contents. Note that the app generating unit 26 determines contents of a terminal app based on schedule contents, for example, such as past app operation history and future user action schedule and so forth, and generates a terminal app based on the determined contents.

The app generating unit 26 generates a terminal app based on a terminal app template stored beforehand in the storage unit 23. Note that the app generating unit 26 includes an in-use situation prediction unit 41-1 and a contents adjustment unit 41-2.

The in-use situation prediction unit 41-1 predicts a situation at the time of use of an app to be used at the communication terminal 12 for each user. In this case, the in-use situation prediction unit 41-1 may predict a situation at the time of use from the current position, operation contents, and so forth of the communication terminal 12, or may further predict a situation at the time of use of an app based on schedule contents and action history to be obtained by the above schedule management unit 24. The in-use situation prediction unit 41-1 may predict an in-use situation of a user who uses an app, based on a correlation degree for each user situation to be obtained from frequency of a user situation used in the past for each app type, for example.

Also, the contents adjustment unit 41-2 performs adjustment of a terminal app based on a situation at the time of use of an app predicted by the in-use situation prediction unit 41-1, the current situation, the situation and adjustment correspondence DB stored in the storage unit 23, and data in the middle of input. The contents adjustment unit 41-2 changes contents to be displayed on the screen of the communication terminal 12 using the terminal app according to the current situation of the communication terminal 12. Thus, for example, a terminal app predicted to be externally used by a user may be adjusted so that information for internal use only is not included in the contents to be displayed on the screen of the communication terminal 12. Also, the contents adjustment unit 41-2 may be adjusted so as not include information for internal use only in the event that the current situation of the user is outside the company, and so as to also display information for internal use only in the event that the current situation is inside the company. Also, the contents adjustment unit 41-2 stores a predicted in-use situation used for adjustment and the current situation in the estimated situation DB.

The app distribution unit 27 distributes (pushes) various types of data such as an estimated situation and so forth to the target communication terminal 12. Also, the app distribution unit 27 manages data distributed for each communication terminal 12, and accordingly updates the pushed app DB after distribution. Note that the app distribution unit 27 may predict a situation at the time of a user using the communication terminal 12 based on schedule contents obtained by the above schedule management unit 24, and perform distribution of a predetermined terminal app previously or at an appropriate timing in accordance with the predicted situation. For example, in the event that the user is outside the company, and distributes a terminal app including information for internal use only predicted to be used after returning in the company, the terminal app may be distributed after the user returns to the company.

The readjustment accepting unit 28 receives readjustment request data to be obtained from the communication terminal 12, and stores the received readjustment request data in the storage unit 23. Note that the readjustment request data is a list of terminal apps as readjustment targets (readjustment target app list) or the like, but is not restricted to this.

The readjustment accepting unit 28 performs readjustment of a terminal app to be distributed regarding each terminal app within the readjustment target app list. Specifically, the readjustment accepting unit 28 performs regeneration of a terminal app regarding each app within the readjustment target app list, and redistributes the regenerated terminal app to the communication terminal 12 to which the readjustment request data has been transmitted. Note that regeneration of a terminal app is executed by the app generating unit 26, and redistribution of a terminal app is performed by the app distribution unit 27. The readjustment accepting unit 28 performs request therefore on the above units.

The use situation updating unit 29 performs updating of the use situation correlation DB stored in the storage unit 23 based on the use situation of a terminal app obtained from the communication terminal 12. With the present embodiment, according to a use situation of a terminal app for each user, the above readjustment of the terminal app may be performed.

The transmission/reception unit 30 is a communication unit configured to perform transmission/reception of various types of information with an external device such as the communication units 12 via the communication network 13, for example. The transmission/reception unit 30 may receive various types of information and so forth already stored in an external device or the like, and may transmit results processed at the application providing server 11 to an external device or the like via the communication network 13.

The control unit 31 performs overall control of the components of the application providing server 11. Specifically, the control unit 31 performs each control regarding providing of applications, for example, based on instructions or the like from the input unit 21 by the user or the like. Examples of each control mentioned here include schedule management of each user at the schedule management unit 24, execution of a distribution rule by the distribution rule execution unit 25, generation of a terminal app by the app generating unit 26, and distribution of a terminal app by the app distribution unit 27, which have been described above. Also, examples of each control include acceptance of readjustment of an app by the readjustment accepting unit 28, and updating of correlation of a use situation of a terminal app at the communication terminal 12 by the use situation updating unit 29. Note that the types of each control are not restricted to these. The control described above may be performed based on predetermined operation input by execution of a program, user's instructions, or the like, and may periodically be performed with predetermined time interval.

Hardware Configuration Example of Application Providing Server 11

Now, the above application providing server 11 generates an execution program (application providing program) which enables the computer to execute the functions, and installs the execution program thereof in a general-purpose PC or server or the like, thereby realizing application providing processing according to the present embodiment. Now, description will be made regarding a hardware configuration example of the computer whereby the application providing processing according to the present embodiment is executable, with reference to the drawings.

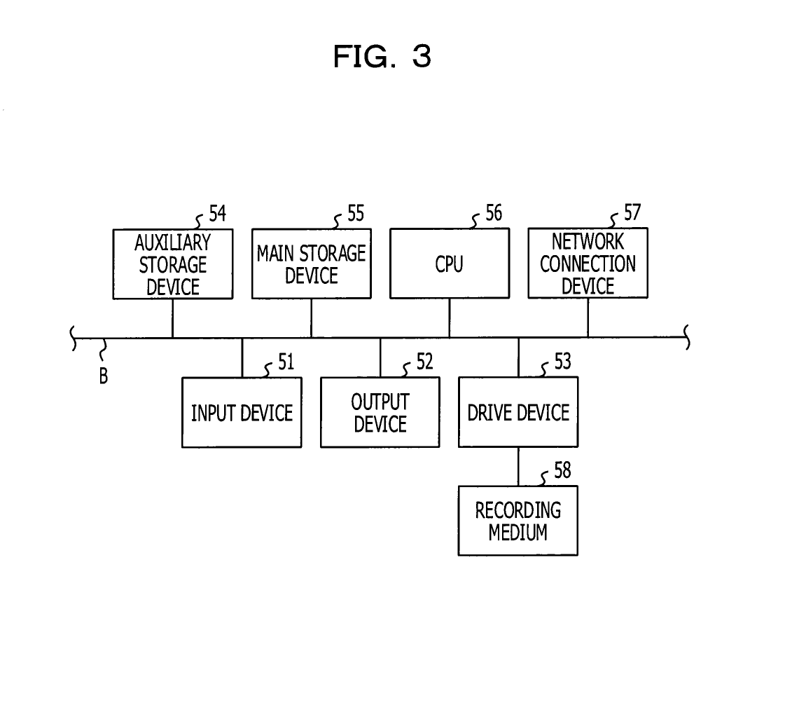

FIG. 3 is a diagram illustrating an example of a hardware configuration in the application providing server. The computer main unit in FIG. 3 is configured so as to include an input device 51, an output device 52, a drive device 53, an auxiliary storage device 54, a main storage device 55, a central processing unit (CPU) 56 which performs various types of control, and a network connection device 57, and these are mutually connected by a system bus B.

The input device 51 includes a pointing device such as a keyboard and mouse and so forth which a user or the like operates, and an audio input device such as a microphone and so forth, and inputs program execution instructions, various types of operation information, information for activating software or the like, and so forth from a user or the like.

The output device 52 includes a display configured to display various windows, data, and so forth used for operating the computer main unit to perform processing according to the present embodiment, and may display execution processes and results and so forth of the program by a control program included in the CPU 56. Also, the output device 52 may print the above processing results and so forth on a printing medium such as paper or the like to present to the user or the like.

Now, an execution program to be installed in the computer main unit in the present embodiment is provided by a portable recording medium 58 or the like, for example, such as Universal Serial Bus (USB) memory, CD-ROM, DVD, or the like. The recording medium 58 in which the program is recorded is settable to the drive device 53, and the execution program included in the recording medium 58 is installed in the auxiliary storage device 54 from the recording medium 58 via the drive device 53 based on a control signal from the CPU 56.

The auxiliary storage device 54 is a storage unit or the like, for example, such as a hard disk drive or solid state drive (SSD) or the like. The auxiliary storage device 54 stores, based on a control signal from the CPU 56, the execution program according to the present embodiment, the control program provided to the computer, and so forth, and may perform input/output as appropriate. The auxiliary storage device 54 may read out or write in information to be used from stored various types of information based on a control signal or the like from the CPU 56.

The main storage device 55 stores the execution program and so forth read out from the auxiliary storage device 54 by the CPU 56. Note that the main storage device 55 is configured of read only memory (ROM), random access memory (RAM), and so forth. Note that the auxiliary storage device 54 and main storage device 55 correspond to the above storage unit 23, for example.

The CPU 56 may realize each process by controlling processing of the entire computer such as various types of calculation, input/output of data as to each hardware component, and so forth, based on a control program such as an operating system or the like, and the execution program stored in the main storage device 55. Note that various types of information and so forth to be used during execution of the program may be obtained from the auxiliary storage device 54, and also execution results and so forth may be stored therein.

Specifically, the CPU 56 performs, based on program execution instructions or the like to be obtained from the input device 51 for example, processing corresponding to the program over the main storage device 55 by executing the application providing program installed in the auxiliary storage device 54. For example, the CPU 56 executes the application providing program, thereby performing control such as schedule management by the schedule management unit 24, execution of a distribution rule by the distribution rule execution unit 25, generation of a terminal app by the app generating unit 26, which are described above, and so forth. Also, the CPU 56 performs processing such as distribution of a terminal app by the app distribution unit 27, acceptance of readjustment of an app by the readjustment accepting unit 28, updating of correlation information of a use situation of a terminal app at a communication terminal 12 by the use situation updating unit 29, and so forth. Note that processing contents at the CPU 56 are not restricted to these. Contents executed by the CPU 56 may be stored in the auxiliary storage device 54 as appropriate.

The network connection device 57 is connected to the communication network 13 or the like based on a control signal from the CPU 56, thereby obtaining an execution program, software, setup information, or the like from an external device or the like connected to the communication network 13. Also, the network connection device 57 may provide execution results obtained by executing a program, or the execution program itself according to the present embodiment to an external device or the like.

According to the hardware configuration such as described above, the application providing processing according to the present embodiment may be executed. Also, the application providing processing according to the present embodiment may readily be realized at a general-purpose PC or server or the like by installing the program.

Function Configuration Example of Communication Terminal 12

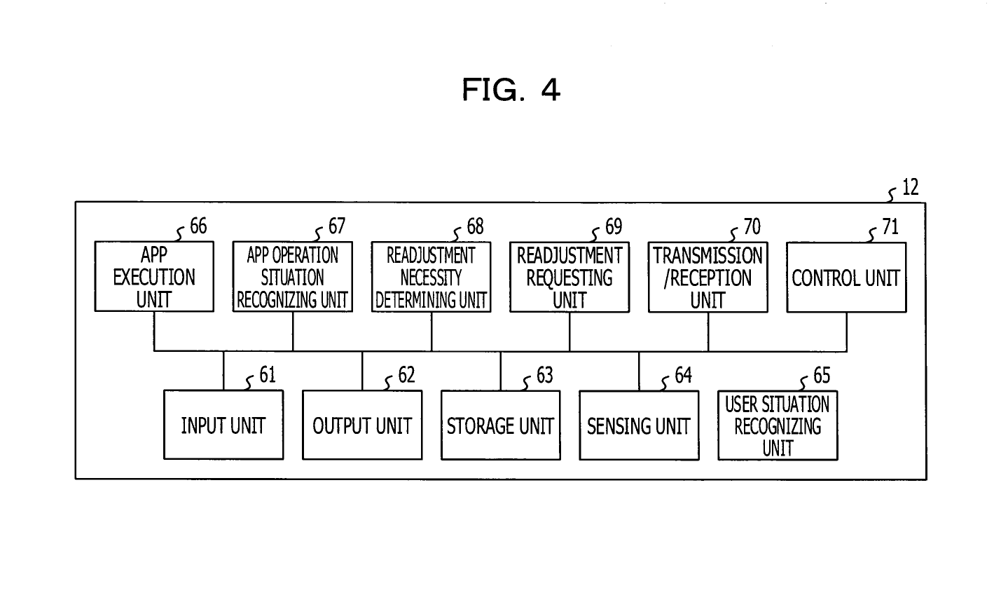

FIG. 4 is a diagram illustrating an example of a function configuration at a communication terminal. The communication terminal 12 illustrated in FIG. 4 includes an input unit 61, an output unit 62, a storage unit 63, a sensing unit 64, a user situation recognizing unit 65, an app execution unit 66, an app operation situation recognizing unit 67, a readjustment necessity determining unit 68, a readjustment request unit 69, a transmission/reception unit 70, and a control unit 71

The input unit 61 accepts various types of input such as start or end of various instructions, input of settings, and so forth from a user or the like who uses a communication terminal 12. Specifically, the input unit 61 accepts each instruction, for example, such as app execution instruction according to the present embodiment, or the like.

Input of information to be obtained from the input unit 61 may be input according to an input interface or the like, for example, such as a predetermined button group (keys) or the like, or may be input in a touch panel format using the screen, or the like. Further, the input unit 61 may include an audio input unit configured to input audio, for example, using a microphone or the like.

The output unit 62 outputs contents input by the input unit 61, contents executed based on the input contents, and so forth. Note that, in the event of outputting contents using screen display for example, the output unit 62 may include a display unit such as a display or monitor or the like, and in the event of outputting contents using audio, may include an audio output unit, for example, such as a speaker or the like. Also, with regard to the input unit 61 and output unit 62, input and output may be an all-in-one type, for example, such as a touch panel or the like.

The storage unit 63 stores various types of information used for the present embodiment. Specifically, the storage unit 63 stores various types of information, for example, such as a user situation DB, data in the middle of input, use history, app operation situation DB, estimated situation DB, and so forth, but the various types of information are not restricted to these. Also, the storage unit 63 stores setup information or the like for executing various types of processing that may be realized by application providing processing according to the present embodiment, or stores execution processes or results or the like of various types of processing. Also, the storage unit 63 may read out or write in stored various types of information at a predetermined timing as appropriate. Also, the storage unit 63 is an aggregation of various types of information such as described above, and may have a function serving as a database systematically configured so as to search for those information using, for example, a keyword or the like, and so as to extract those information. Note that the storage unit 63 is configured of, for example, a hard disk or memory or the like.

The sensing unit 64 is a position information obtaining unit configured to obtain position information (current position), orientation, moving direction, moving speed, and so forth of the communication terminal 12, for example. In this case, the sensing unit 64 has, for example, a GPS function for obtaining position information, and performs positioning according to the GPS function, thereby obtaining position information made up of latitude longitude, or position information replaced with a predetermined coordinates system. Also, in the event that the sensing unit 64 has a short distance communication function such as WiFi (registered trademark) or Bluetooth (registered trademark) or the like, the sensing unit 64 may obtain position information of another terminal (relay device or radio base station or the like) which is communicable using short distance communication as the position information of the communication terminal 12.

Also, the sensing unit 64 has, for example, an acceleration sensor or angular velocity sensor or the like, whereby the orientation, moving direction, moving speed, and so forth of the communication terminal 12 may be obtained though not restricted to these.

For example, in the event that updating processing of the user situation has been executed periodically or at a predetermined timing, and the user situation has been changed, the user situation recognizing unit 65 outputs the changed user situation to the readjustment necessity determining unit 68 so as to perform determination of readjustment necessity.

The app execution unit 66 activates a terminal app in a usable state to be obtained from the application providing server 11 at a predetermined timing so as to go into an executable state. Note that the terminal app has been distributed in accordance with a situation at the time of being used by the user being predicted beforehand by the application providing server 11. Information to be obtained by execution of the terminal app is stored in the storage unit 63 as use history, and is transmitted to the application providing server 11 at a predetermined timing.

Also, an arrangement may be made wherein the app execution unit 66 obtains an app list from a later-described app DB or the like at the time of start-up, displays this on the screen, and activates an app selected by the user of displayed app. Also, an arrangement may be made wherein the app execution unit 66 obtains a user situation, and updates use history in a manner correlated with the obtained user situation.

The app operation situation recognizing unit 67 recognizes a situation of an app operation used (executed) by the user. The contents of the recognized situation may be stored in the storage unit 63, or may be transmitted to the application providing server 11 via the communication network 13.

The readjustment necessity determining unit 68 determines necessity of readjustment of the terminal app according to a predetermined condition, generates an app list including a terminal app calling for readjustment based on the determination result, and outputs the generated app list calling for readjustment to the readjustment request unit 69.

The readjustment request unit 69 generates readjustment request data regarding each app of the app list obtained by the readjustment necessity determining unit 68. The generated readjustment request data is transmitted to the application providing server 11 by the transmission/reception unit 70 via the communication network 13.

The transmission/reception unit 70 is a communication unit configured to perform transmission/reception of various types of information as to an external device such as the application providing server 11 or the like via the communication network 13, for example. The transmission/reception unit 70 may receive various types of information and so forth already stored in an external device or the like, and also transmit results processed at a communication terminal 12 to an external device or the like via the communication network 13.

Specifically, the transmission/reception unit 70 receives various types of data such as a terminal app (including an adjusted app and so forth), an estimated situation, and so forth to be obtained from the application providing server 11, and stores these data in the storage unit 63 or the like of the app DB or estimated situation DB or the like, for example.

The control unit 71 performs overall control of the components of a communication terminal 12. Specifically, the control unit 71 performs each control regarding providing of an application, for example, based on instructions or the like from the input unit 61 by the user or the like. Examples of each control mentioned here include obtaining of position information and so forth of a communication terminal 12 by the sensing unit 64, recognizing of a user situation by the user situation recognizing unit 65, app execution by the app execution unit 66, recognizing of an app operation situation by the app operation situation recognizing unit 67, readjustment necessity determination by the readjustment necessity determining unit 68, and readjustment request by the readjustment request unit 69, which are described above. Note that the type of each control is not restricted to these. Note that control regarding these may be performed based on predetermined operation input by execution of a program or user's instructions or the like, or may be performed periodically with a predetermined time interval.

Hardware Configuration Example of Communication Terminal 12

With the communication terminals 12 as mentioned above, application execution processing according to the present embodiment may be realized by generating an execution program (application execution program) causing the computer to execute the functions, and installing the execution program thereof in, for example, a smartphone or tablet terminal or the like. Now, description will be made regarding a hardware configuration example of a computer which is realizable by the application execution processing according to the present embodiment, with reference to the drawings.

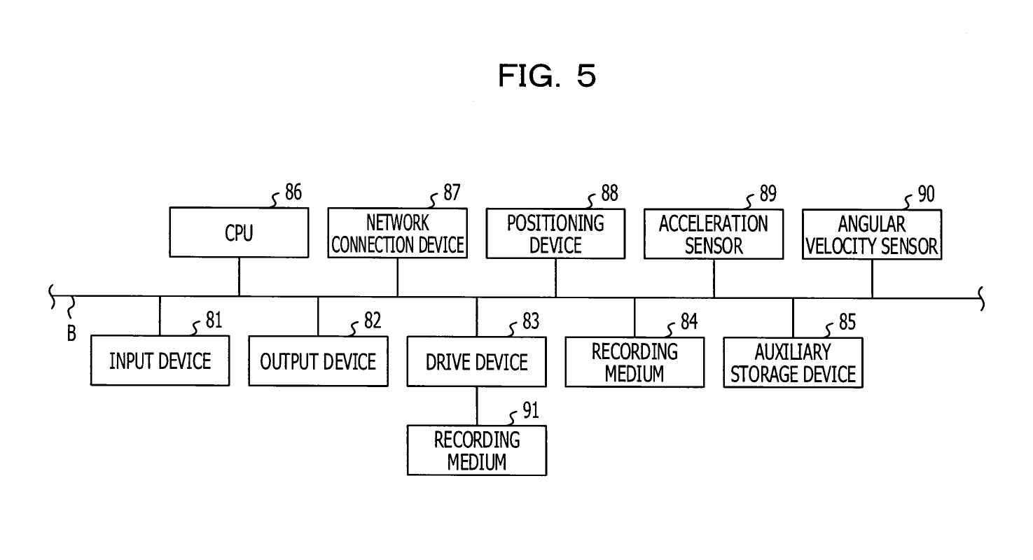

FIG. 5 is a diagram illustrating an example of a hardware configuration in a communication terminal. A computer main unit in FIG. 5 includes an input device 81, an output device 82, a drive device 83, an auxiliary storage device 84, a main storage device 85, a CPU 86, a network connection device 87, a positioning device 88, an acceleration sensor 89, and an angular velocity sensor 90, and these are mutually connected by a system bus B.

The input device 81 includes a pointing device such as a keyboard and mouse and so forth which a user of the communication terminal 12 or the like operates, and an audio input device such as a microphone and so forth, for example. The input device 81 inputs program execution instructions, various types of operation information, setup information, information for activating software or the like, and so forth from the user or the like.

The output device 82 includes a display configured to display various windows, data, and so forth used for operating the computer main unit to perform processing according to the present embodiment, and may display execution processes and results and so forth of the program by a control program included in the CPU 86.

Now, an execution program to be installed in the computer main unit in the present embodiment is provided by a portable recording medium 91 or the like, for example, such as a memory card, USB memory, or the like. The recording medium 91 in which the program is recorded is settable to the drive device 83, and the execution program included in the recording medium 91 is installed in the auxiliary storage device 84 from the recording medium 91 via the drive device 83 based on a control signal from the CPU 86.

The auxiliary storage device 84 is a storage unit or the like, for example, such as a hard disk drive or SSD or the like. The auxiliary storage device 84 stores, based on a control signal from the CPU 86, the execution program according to the present embodiment, the control program provided to the computer, execution processes, execution results, and so forth. Also, the auxiliary storage device 84 may read out or write in information to be used from stored various types of information based on a control signal or the like from the CPU 86.

The main storage device 85 stores the execution program and so forth read out from the auxiliary storage device 84 by the CPU 86. Note that the main storage device 85 is, for example, ROM, RAM, and so forth.

The CPU 86 may realize each process by controlling processing of the entire computer such as various types of calculation, input/output of data as to each hardware component, and so forth, based on a control program such as an operating system or the like, and the execution program stored in the main storage device 85. Note that various types of information and so forth to be used during execution of the program may be obtained from the auxiliary storage device 84, and also execution results and so forth may be stored therein.

Specifically, the CPU 86 performs, based on program execution instructions or the like to be obtained from the input device 81 for example, processing corresponding to the program over the main storage device 85 by executing the program installed in the auxiliary storage device 84.

For example, the CPU 86 executes the program, thereby performing execution control, for example, such as obtaining of position information and so forth of the communication terminal 12 by the above sensing unit 64, recognizing of a user situation by the user situation recognizing unit 65, app execution by the app execution unit 66, and so forth. Also, the CPU 86 performs execution control such as recognizing of an app operation situation by the app operation situation recognizing unit 67, determination of readjustment necessity by the readjustment necessity determining unit 68, readjustment request by the readjustment request unit 69, and so forth. Note that processing contents at the CPU 86 are not restricted to the contents described above. Contents (execution processes and execution results) executed by the CPU 86, and so forth may be stored in the auxiliary storage device 84 as appropriate.

The network connection device 87 is connected to the communication network 13 or the like based on a control signal from the CPU 86, thereby obtaining an execution program, software, various commands, or the like from an external device or the like connected to the communication network 13. Also, the network connection device 87 may provide execution results obtained by executing a program, or the execution program itself according to the present embodiment to an external device or the like.

Note that the network connection device 87 may be a communication unit which enables communication using WiFi (registered trademark) or Bluetooth (registered trademark) or the like, for example. Also, the network connection device 87 may be a communication unit which enables speech as to a phone terminal. Further, the network connection device 87 may be a combination of the above configurations.

The positioning device 88 receives, as a GPS function for example, GPS data transmitted from a GPS satellite to obtain the current positioning information (e.g., positioning coordinates or the like) of the communication terminal 12. Also, the positioning device 88 may obtain, in addition to positioning using the GPS function, position information of the communication terminal 12 based on position information of a relay device or radio base station or the like which performs transmission/reception of data. In this case, as for the position information, position information of a radio base station or relay device or the like may be employed, for example. Further, the positioning device 88 obtains position information in time sequence per increment time, whereby speed information from displacement of the obtained position information per increment time may be obtained.

The acceleration sensor 89 obtains gravitational acceleration information for each of triaxial directions (X axial direction, Y axial direction, Z axial direction) of the communication terminal 12 in time sequence per increment time. The angular velocity sensor 90 obtains rotational amount (orientation) at the time of motion of the communication terminal 12 in time sequence per increment time. That is to say, the acceleration sensor 89 and angular velocity sensor 90 are sensors configured to obtain the position and direction and so forth of the communication terminal 12, which may be measured by another sensor system or the like. According to a hardware configuration such as described above, the application execution processing according to the present embodiment may be executed.

### Various Data Examples

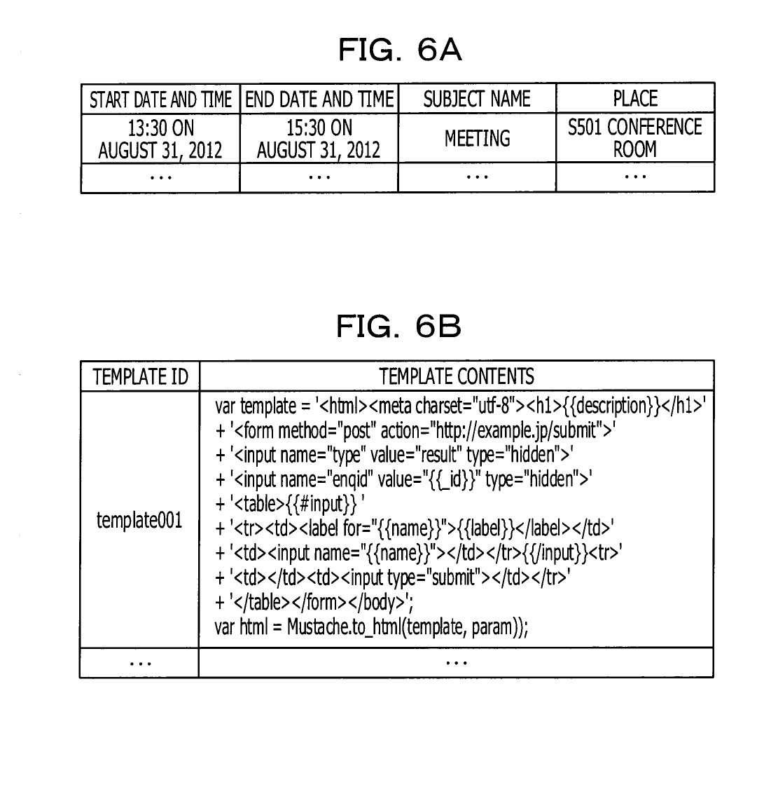

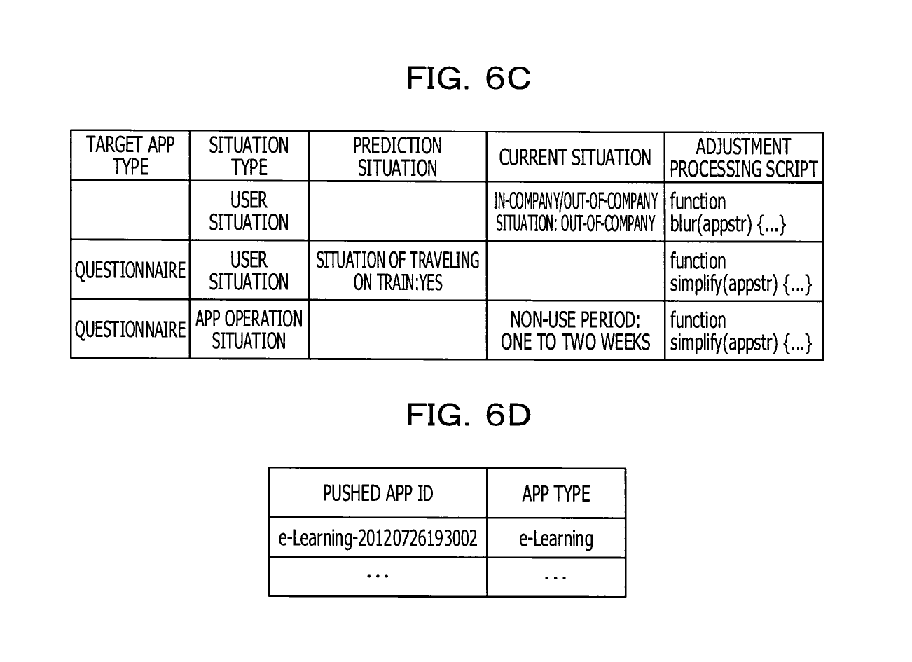

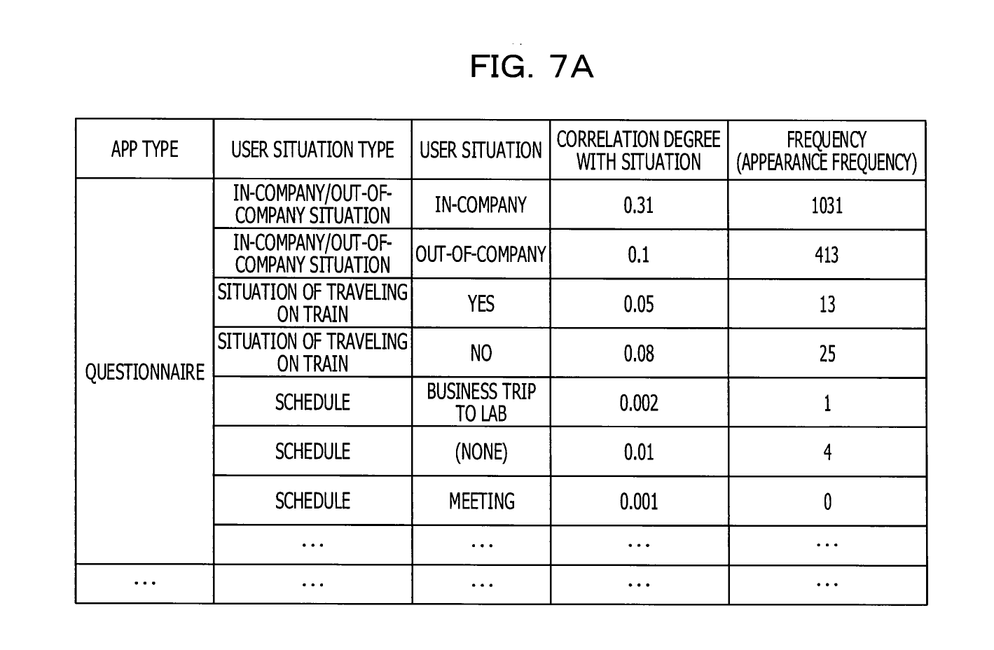

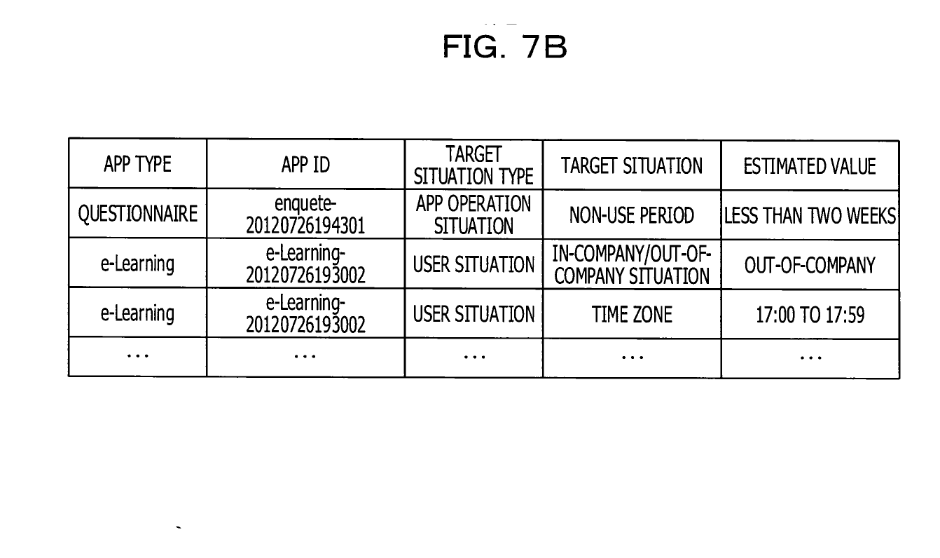

Now, description will be made regarding various data examples to be stored in the storage unit 23 of the application providing server 11, and the storage unit 63 of the communication terminal 12, which have been described above, with reference to the drawings. FIGS. 6A to 6D, and FIGS. 7A and 7B are first and second diagrams illustrating a data example to be stored in the application providing server.

FIG. 6A illustrates a data example of a schedule DB. With the schedule DB illustrating FIG. 6A, schedule contents such as future action schedule (subject) set beforehand for each user, and so forth are stored. Note that, with the schedule DB, past history information may be stored, for example. Items of the schedule DB include start date and time, end date and time, subject, and place though not restricted to these, and may include user identification information for identifying a user, and so forth, for example.

FIG. 6B illustrates a data example of a terminal app template. The terminal app template illustrated in FIG. 6B is a template set beforehand to be used for the app generating unit 26 generating a terminal app. With the terminal app template, for example, identification information (template ID) for identifying a template, and contents corresponding to the template thereof are stored in a correlated manner. The terminal app template includes one or multiple parameter portions as illustrated in FIG. 6B, and a variable value may be set to each parameter, whereby a terminal app adapted to each user may be generated.

With the terminal app template, a template for each operation increment to be used for an application is managed for each ID. The app generating unit 26 selects a template corresponding to the current situation or the like of the communication terminal 12 from multiple app templates stored beforehand, and replaces each parameter portion of the template thereof with the corresponding value of the method argument parameters, for example. Note that the above processing may be obtained using a template engine for HTML or the like set beforehand though not restricted to this.

Also, FIG. 6C illustrates a data example of the situation and adjustment correspondence DB. With the situation and adjustment correspondence DB illustrated in FIG. 6C, a target app type, a situation type, a predicted situation (predicted in-use situation), the current situation, and so forth as conditions for the script thereof being executed are set to a later-described adjustment processing script, for example.

Specifically, with the situation and adjustment correspondence DB, a predicted situation, the current situation, and so forth corresponding to a target app type and situation type and so forth are stored. Also, with the situation and adjustment correspondence DB, a predicted situation, a script and so forth for adjusting contents of an app to be generated from the terminal app template are stored in a manner correlated with a stored situation and so forth. Note that the situation and adjustment correspondence DB is referenced by the above contents adjustment unit 41-2, for example.

Now, with the situation and adjustment correspondence DB, in the event that “target app type” is “empty”, the adjustment processing script is applied to all of the app types. Also, in the event that “predicted situation” or “current situation” is “empty”, the adjustment processing script is applied to each of all situations. In many cases, the script is executed based on “predicted situation” alone, and “current situation” is set to “empty”. However, with regard to “in-company/out-of-company situation” as one of the situations, operation based on the current situation has to be performed, and accordingly, the predicted situation with “empty” is registered.

For example, in the event that “current situation” is “out-of-company”, and “predicted situation” is “in-company”, there is set an adjustment processing script for avoiding information for internal use only from being included in the screen of an app to be executed at the communication terminal 12. Also, in the event that “target app type” is “questionnaire”, “situation type” is “app operation situation”, and “current situation” is “non-use period one to two weeks”, there is set an adjustment processing script for adjusting only significant items by decreasing the questionnaire items. Note that contents of an adjustment processing script to be set are not restricted to these.

Also, FIG. 6D illustrates a data example of the pushed app DB. With the pushed app DB illustrated in FIG. 6D, identification information (pushed app ID) for identifying a pushed app transmitted from the application providing server 11 to the communication terminal 12, and an app type are stored in a correlated manner, for example. The pushed app DB is referenced for obtaining an app type from a pushed app ID at the time of updating an app in-use situation correlation DB illustrated in FIG. 7A. Note that, in order to manage which of the communication terminals 12 an app has been distributed to, user identification information, terminal identification information, and so forth may be included in the pushed app DB.

Also, FIG. 7A illustrates a data example of the app in-use situation correlation DB. As items of the app in-use situation correlation DB illustrated in FIG. 7A, an app type, a user situation type, a user situation, a correlation degree with a situation, and frequency (appearance frequency) are included for example though not restricted to these.

The app in-use situation correlation DB is a DB to be used for predicting an app in-use situation. Specifically, with the app in-use situation correlation DB, which app is used in what kind of user situation is managed by a correlation degree (probability) with another user situation and so forth for each app type. With the app in-use situation correlation DB, “frequency (appearance frequency)” stores the number of times for each user situation at the time of the app thereof being used in the past. Also, “frequency (appearance frequency)” is updated by the use situation updating unit 29, and “a correlation degree with a situation” is updated based on the updated frequency information and so forth.

Also, FIG. 7B illustrates a data example of the estimated situation DB. As items of the estimated situation DB illustrated in FIG. 7B, an app type, an app ID, a target situation type, and an estimated value are included though not restricted to these.

The estimated situation DB is provided to both of the communication terminals 12 and application providing server 11. The estimated situation DB over a communication terminal 12 is updated at the time of reception of an app from the application providing server 11, and is used for determining necessity of readjustment.

Also, of the estimated situation DB over the application providing server 11, input in the event that the target situation type is “app operation situation” is updated by an app developer or the like, for example. Also, input in the event that the target situation type is “user situation” is set to the value of a predicted in-use situation that the app generating unit 26 using the in-use situation prediction unit 41-1. With the application providing server 11, in the event that there is an estimated situation for the corresponding app at the time of app distribution, this is transferred to the communication terminal 12 being included in the distribution data.

As the estimated situation DB, “target situation” and “estimated value” thereof are stored, and accordingly, for example, even in the event that “time zone” to be predicted that the app will be used, and so forth are stored, and the user comes to the company and goes outside the company many times, adjustment at the time of change in situations in the middle may be suppressed, and a suitable app may be provided.

Note that the above estimated situation DB illustrated in FIG. 7B may also be used for performing adjustment by checking whether the pushed app has been adjusted based on what kind of situation at the time of readjustment, and by taking change in the situation thereof into consideration. For example, in the event that an app has been regenerated, instead of transferring all thereof, difference data for changing a portion of the transferred app is transferred to the communication terminal 12, the estimated situation DB may be used for determining a changed portion. For example, an arrangement may be made wherein along with change in situations, in the event of performing processing such as how to change which portion within an app, an adjustment processing script corresponding to the situation is obtained with reference to the estimated situation DB, and the obtained script is executed.

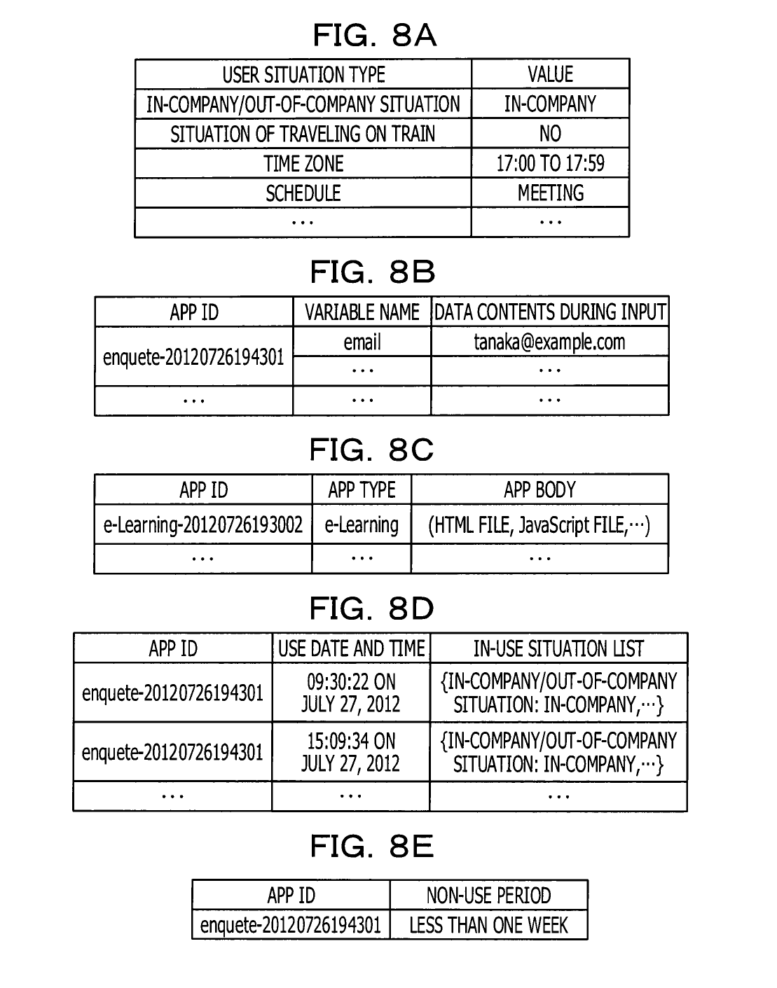

FIGS. 8A to 8E are diagrams illustrating a data example to be stored in communication terminals. FIG. 8A illustrates a data example of a user situation DB. With the user situation DB illustrated in FIG. 8A, data to be updated by the user situation recognizing unit 65 is stored. As items of the user situation DB, a user situation type and a value thereof are included though not restricted to these.

With the example in FIG. 8A, there are illustrated a data example wherein the user situation type is “in-company/out-of-company situation”, and a value thereof is “in-company”, and a data example wherein the user situation type is “situation of traveling on train”, and a value thereof is “No”. A plurality of data is stored according to difference of user situations. The user situation DB illustrated in FIG. 8A is used in the event of performing readjustment necessity determination, or app in-use situation prediction, or the like, for example.

Also, FIG. 8B illustrates a data example of data in the middle of input. The data in the middle of input illustrated in FIG. 8B is data to be stored in the middle of input thereof in the event that a terminal app being executed at a communication terminal 12 being terminated in the middle of input.

Note that the data in the middle of input is data for enabling input of the data to be continued in a manner wherein the data which has been input so far is reflected, in the event that the terminal app has been terminated in the middle of execution, and has been activated again. The data in the middle of input is used at the time of readjustment to perform adjustment such as embedding as an input value, or omitting an input item in the event that there is the data in the middle of input, or the like.

As items of the data in the middle of input, an app ID, a variable name, and data contents in the middle of input are included though not restricted to these. Storing of the data in the middle of input may be realized though not restricted to this by having a function for storing contents input so far in the storage unit 63 within the communication terminal 12 in the event that a terminal app is terminated in the middle of input.

Also, FIG. 8C illustrates a data example of an app DB. The app DB illustrated in FIG. 8C stores an app list of a terminal app and app bodies included in the communication terminal 12. With the present embodiment, FIG. 8C may also be used for the app execution unit 66 displaying the app list on the screen. As items of the app DB, for example, an app ID, an app type, and an app body are included though not restricted to these. The app type is used for the above readjustment request unit 69 obtaining, in the event of only an app type being passed, an app ID from the app type thereof.

Also, as the app body, each file body for executing an app, for example, such as an HTML5 file or JavaScript file or the like is stored.

Also, FIG. 8D illustrates a data example of a use history DB. As items of the use history DB illustrated in FIG. 8D, for example, an app ID, use date and time, and an in-use situation list are included though not restricted to these.

The “in-use situation list” included in the use history DB is for updating the app in-use situation correlation DB illustrated in FIG. 7A described above. Accordingly, the use history DB is transmitted to the application providing server 11 periodically or at a predetermined timing. Also, the “use date and time” is for updating a non-use period of a later-described app operation situation DB illustrated in FIG. 8E.

Also, FIG. 8E illustrates a data example of an app operation situation DB. With the app operation situation DB illustrated in FIG. 8E, data to be used for determining readjustment necessity at the readjustment necessity determining unit 68 described above is stored. With the app operation situation DB, an app ID and a non-use period are stored in a correlated manner, for example. Note that the app operation situation DB is transmitted to the application providing server 11 periodically or at a predetermined timing.

Note that, with the present embodiment, as illustrated in FIGS. 7A, 8A, and others, for example, a user's action schedule is obtained, and “schedule” is included as a target user situation, whereby adjustment at a suitable timing based on the schedule, or more suitable adjustment necessity determination, or the like may be performed.

Application Providing Processing and Application Execution Processing

Next, description will be made regarding application providing processing in the application providing server 11, and application execution processing in the communication terminals 12, with reference to the flowchart and so forth.

First-Time Terminal App Generation Processing

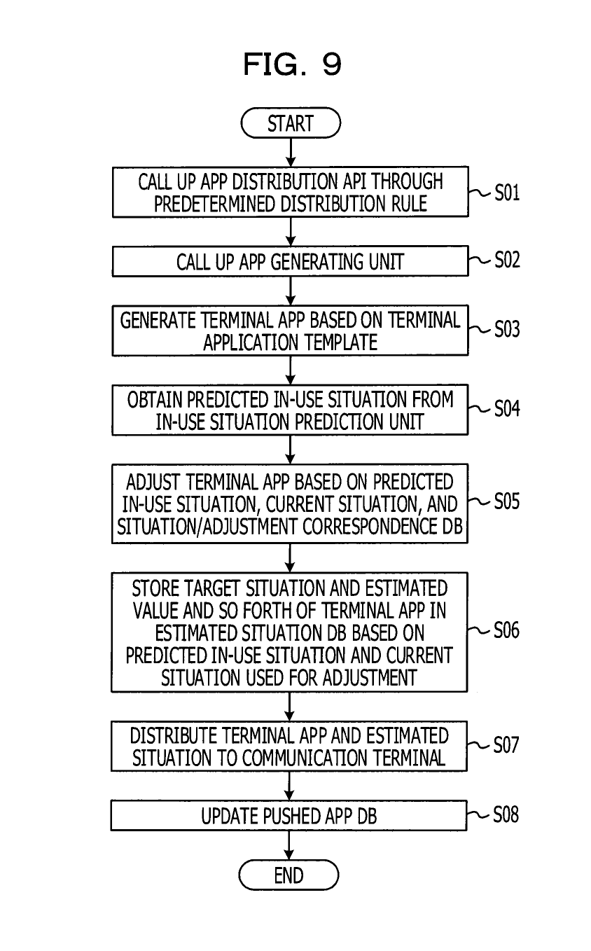

FIG. 9 is a flowchart illustrating an example of first-time terminal app generation processing. With the example in FIG. 9, processing at the time of generation and distribution of a terminal app at the first time will be described as an example of the application providing processing at the application providing server 11.

With the generation processing illustrated in the example in FIG. 9, first, in accordance with the distribution rule execution unit 25, a certain predetermined distribution rule (e.g., “distribution rule 1”) calls up an app distribution application programming interface (API) (S01).

Note that, the certain predetermined distribution rule is a distribution rule wherein in the event that the user has come to an exit of a seminar room or the like for example, a questionnaire answer situation is obtained, and when the questionnaire is unanswered, a questionnaire form is transmitted to the user thereof, but the distribution rule is not restricted to this. Specifically, the application providing server 11 causes the distribution execution unit 25 to execute the predetermined distribution rule, and also receives operation contents, the current position, and so forth from a communication terminal 12, and periodically determines whether or not a predetermined condition for generating an app is satisfied.

Next, in the event that the predetermined condition in the distribution rule 1 is satisfied, the generation processing causes the distribution rule execution unit 25 to call up the app generating unit 26 (S02). Also, the generation processing causes the app generating unit 26 to generate a terminal app using a predetermined app template as illustrated in FIG. 6B described above (S03). Also, the generation processing obtains a predicted in-use situation from the in-use situation prediction unit 41-1 (S04).

Next, the generation processing causes the contents adjustment unit 41-2 to adjust a terminal app based on the predicted situation at the time of use (predicted in-use situation), the current situation, and the situation and adjustment correspondence DB illustrated in FIG. 6C described above (S05). Also, the generation processing sets the target situation, estimated value, and so forth of a terminal app or the like based on the predicted in-use situation used for adjustment by the contents adjustment unit 41-2 and the current situation, and stores these in the estimated situation DB (S06).

Also, the generation processing causes the app distribution unit 27 to distribute the terminal app and the estimated situation included in the estimated situation DB to the target communication terminal 12 (S07), and updates the pushed app DB as illustrated FIG. 6D described above (S08).

As described above, the terminal app and the contents of the estimated situation DB transmitted from the application providing server 11 are received at the transmission/reception unit 70 of the communication terminal 12, and are stored in the app DB (FIG. 8C) and estimated situation DB of the storage unit 63, respectively.

Readjustment Processing at Time of Change in User Situation

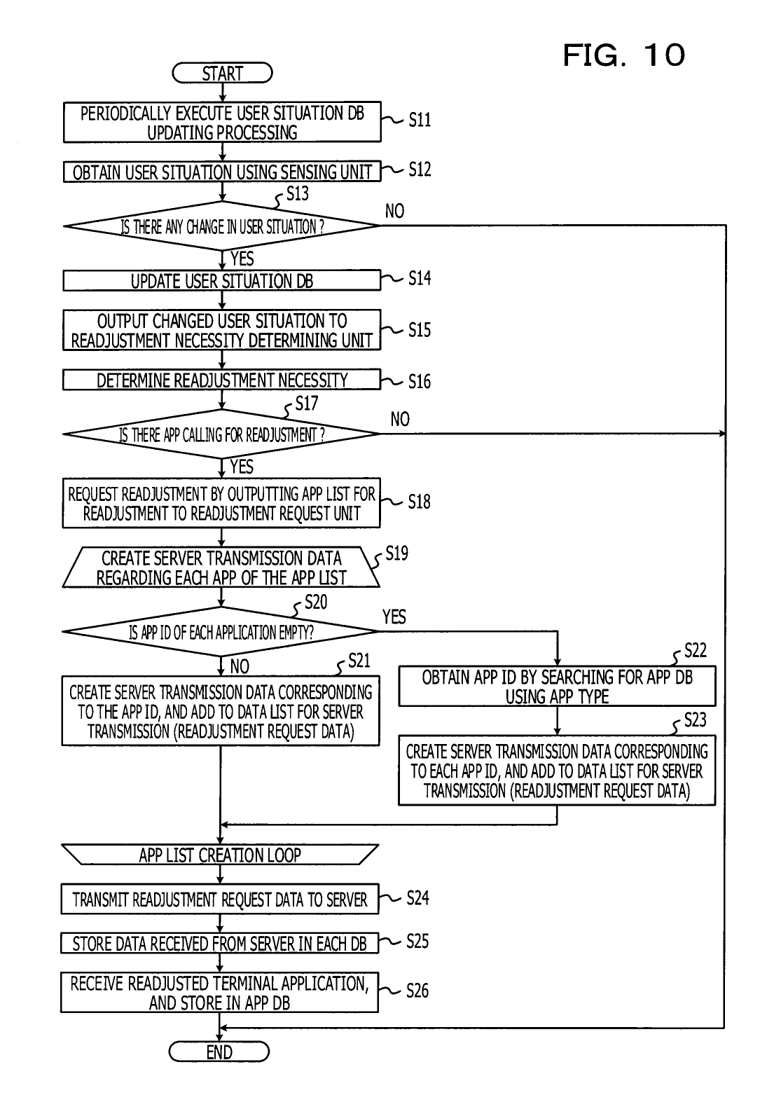

FIG. 10 is a flowchart illustrating an example of readjustment processing at the time of change in the user situation. The example in FIG. 10 illustrates readjustment processing of a terminal app at the time of change in the user situation as an example of application execution processing at the communication terminals 12.

The readjustment processing illustrated in the example in FIG. 10 causes the user situation recognizing unit 65 to execute updating processing of the user situation DB illustrated in FIG. 8A periodically or at a predetermined timing such as change in the user situation or the like (S11). Also, the readjustment processing causes the sensing unit 64 to obtain a user situation along with the current position or moving direction or the like of the communication terminal 12 (S12).

Next, the readjustment processing determines whether or not the user situation has been changed (S13), and in the event that the user situation has been changed (YES in S13), causes the user situation recognizing unit 65 to update the user situation DB (S14), and outputs the changed user situation to the readjustment necessity determining unit 68 (S15). Also, the readjustment processing causes the readjustment necessity determining unit 68 to determine readjustment necessity (S16), and to determine whether or not there is an app calling for readjustment (S17).

In the event that there is an app calling for readjustment (YES in S17), the readjustment processing outputs the app list for readjustment (e.g., app type, app ID, etc.) to the readjustment request unit 69 to request readjustment (S18).

Next, the readjustment processing creates server transmission data to be transmitted to the application providing server 11 as to each app of the app list (S19). Specifically, processing in S20 to S23 is repeated until end of the app list (app list creation loop).

The readjustment processing determines whether or not the app ID of each app is empty (S20), in the event that the app ID is not empty (NO in S20), creates server transmission data corresponding to the app ID, and adds to a data list for server transmission (readjustment request data) (S21).

Also, in the event that the app ID is empty (YES in S20), the readjustment processing searches for the app DB illustrated in FIG. 8C to obtain an app ID (S22). Also, the readjustment processing creates server transmission data corresponding to each app ID, and adds to the data list for server transmission (readjustment request data) (S23).

Next, the readjustment processing causes the readjustment request unit 69 to transmit readjustment request data to the application providing server 11 (S24). Also, the readjustment processing receives various types of data and so forth transmitted from the application providing server 11 corresponding to the processing in S24, and stores the received data to each DB (S25). Also, the readjustment processing receives the terminal app readjusted by the application providing server 11, stores in the app DB illustrated in FIG. 8C (S26), and the readjustment processing is ended.

Note that, in the event that the user situation has not been changed in the processing in S13 (NO in S13), or in the event that there is no app calling for readjustment in the processing in S17 (NO in S17), the readjustment processing is ended.

App Readjustment Processing on Server Side

Note that, with regard to app readjustment processing on the application providing server side, the above processing in S03 to S08 illustrated in FIG. 9 has to be performed on each app within the readjustment target app list transmitted from the communication terminal 12, and accordingly, specific description will be omitted here.

Note that, with the processing in FIG. 10, the server transmission data regarding each app ID includes data in the middle of input, app operation situation DB, and use history DB, and the eventual server transmission data (readjustment request data) further includes the user situation DB.

App in-Use Situation Prediction Processing

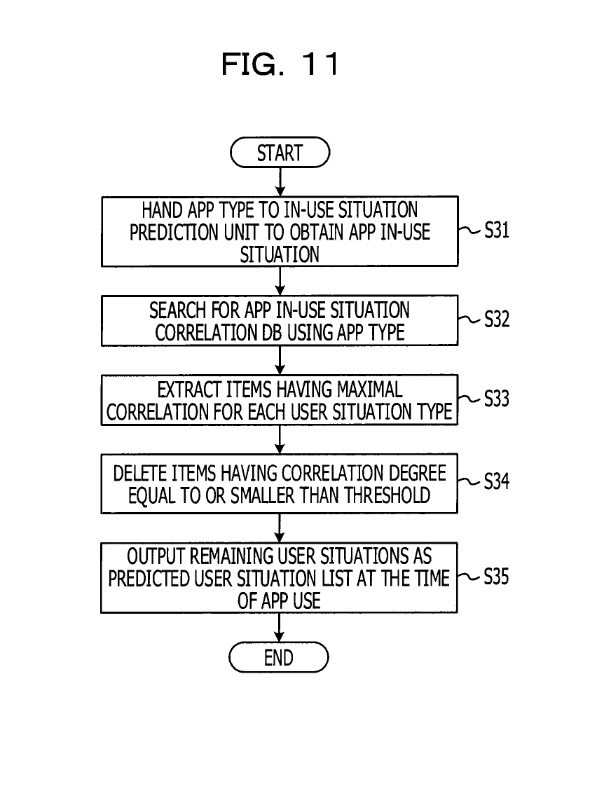

Now, the prediction processing of a predicted in-use situation at the in-use situation prediction unit 41-1 described above as an example of the application providing processing will specifically be described with reference to the flowchart. FIG. 11 is a flowchart illustrating an example of the prediction processing of a predicted in-use situation. The prediction processing illustrated in FIG. 11 first causes the app generating unit 26 to hand an app type to the in-use situation prediction unit 41-1 to obtain an app in-use situation (S31), and searches for the app in-use situation correlation DB using the app type as illustrated in FIG. 7A described above (S32).

Next, the prediction processing extracts an item of which the correlation degree is the maximum for each user situation type included the app in-use situation correlation DB (S33). With the example in FIG. 7A, “in-company/out-of-company situation: in-company” (correlation degree: 0.31), “situation of traveling on train: No” (correlation degree: 0.08), and “schedule: (none)” (correlation degree: 0.01) are extracted.

Also, the prediction processing deletes, of the extracted items, an item of which the correlation degree is equal to or smaller than a threshold set beforehand (S34), and outputs the remaining user situation to the app generating unit 26 as a predicted app in-use user situation list (S35).

For example, a condition has been set beforehand wherein at the time of obtaining a predicted user situation from the app in-use situation correlation DB illustrated in FIG. 7A, an item of which the correlation degree is equal to or smaller than 0.3 is deleted. In this case, as the eventual user situation list, in the event that the app type is “questionnaire”, “in-company/out-of-company situation” as the user situation type, and “in-company” as the user situation are output.

App in-Use Situation Correlation DB Updating Processing

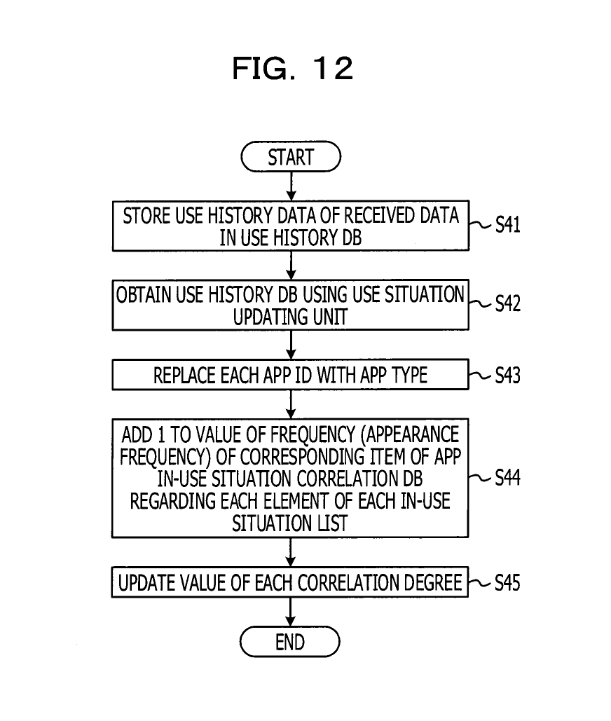

Next, the updating processing of the app in-use situation correlation DB illustrated in FIG. 7A described in the use situation updating unit 29 as an example of the application providing processing will specifically be described with reference to the flowchart. FIG. 12 is a flowchart illustrating an example of the updating processing of the app in-use situation correlation DB.

The use situation updating processing illustrated in the example in FIG. 12 first causes the readjustment accepting unit 28 to store a use history DB within data received from the communication terminal 12 (S41). Next, the use situation updating processing causes the use situation updating unit 29 to obtain the use history DB stored in the storage unit 23 (S42), and replaces each app ID with the app type (S43). Note that the processing in S43 searches for the pushed app DB using the app ID to obtain an app type.

Next, the use situation updating processing increments (+1) frequency (e.g., appearance frequency or the like) of the corresponding item of the app in-use situation correlation DB regarding each element in each in-use situation list (S44). Thereafter, the use situation updating processing updates the value of each correlation degree by dividing frequency for each item by total frequency (frequency/total frequency) (S45).

Contents Adjustment Processing of Terminal App

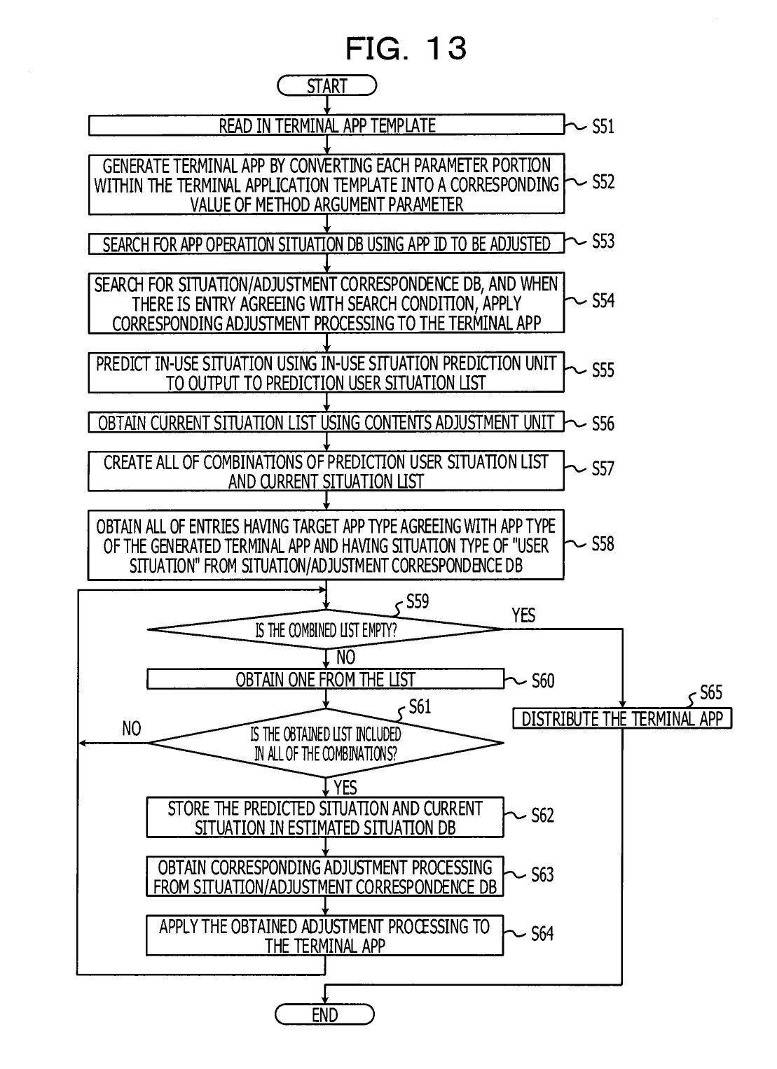

Next, the contents adjustment processing at the contents adjustment unit 41-2 as an example of the application providing processing will specifically be described with reference to the flowchart. FIG. 13 is a flowchart illustrating an example of the contents adjustment processing.

The contents adjustment processing illustrated in the example in FIG. 13 reads the terminal app template illustrated in FIG. 6B described above in the app generating unit 26 (S51). Also, the contents adjustment processing causes the app generating unit 26 to generate a terminal app by replacing each parameter portion within the terminal app template with a value corresponding to a method argument parameter (S52).

Next, the contents adjustment processing causes the contents adjustment unit 41-2 to search the app operation situation DB illustrated in FIG. 8E described above using an app ID to be adjusted (S53). According to this search, the contents adjustment processing obtains the current app operation situation.

Next, the contents adjustment processing searches for the situation and adjustment correspondence DB illustrated in FIG. 6C described above, and in the event that there is an entry agreeing with search conditions, applies the corresponding adjustment processing to the terminal app (S54). Note that examples of the search conditions include a case where the target app type is the same as the app type of the generated terminal app., the situation type is “app operation situation”, and the current situation is the same as the current app operation situation though not restricted to this.

Also, the contents adjustment processing causes the in-use situation prediction unit 41-1 to predict an in-use situation, and outputs a predicted user situation list including the predicted result (S55). Next, the contents adjustment processing causes the contents adjustment unit 41-2 to obtain the current situation list from the in-use situation prediction unit 41-1 (S56), and creates all combinations of predicted user situation lists and the current situation list (S57).

Also, the contents adjustment processing obtains all entries where the target app type agrees with the app type of the generated terminal app, and the situation type is “user situation”, from the situation and adjustment correspondence DB illustrated in FIG. 6C (S58). Note that, with the processing in S58, a list of a set of a predicted situation (predicted in-use situation) and the current situation may be created.

Next, the contents adjustment processing determines whether the list of the set of the predicted situation and the current situation is empty (S59), and in the event that the list is not empty (NO in S59), obtains one from the list (S60). Also, the contents adjustment processing determines whether or not the obtained one of the list is included in all of combinations obtained by the processing in S57 described above (S61).

Now, in the event that the obtained one of the list is not included in all of combinations (NO in S61), the contents adjustment processing returns to the processing in S59. Also, in the event that the obtained one of the list is included in all of combinations (YES in S61), the contents adjustment processing stores the predicted situation and current situation in the estimated situation DB (S62). Specifically, for example, the contents adjustment processing stores the target situation or estimated value or the like of the terminal app to be used or the like in the estimated situation DB based on the predicted situation and current situation. Also, the contents adjustment processing obtains the corresponding adjustment process (e.g., script or the like) from the situation and adjustment correspondence DB (S63). Also, the contents adjustment processing applies the obtained adjustment processing to the terminal app (S64), and returns to the processing in S59. Note that, with the processing in S64, all of adjustment processes agreeing with the situation may be applied though not restricted to this.

Also, in the event that the list is empty in the processing in S59 described above (YES in S59), the contents adjustment processing distributes the terminal app (S65), and the processing is ended.

Readjustment Necessity Determination Processing

Next, the readjustment necessity determination processing at the readjustment necessity determining unit 68 as an example of the application execution processing will specifically be described with reference to the flowchart.

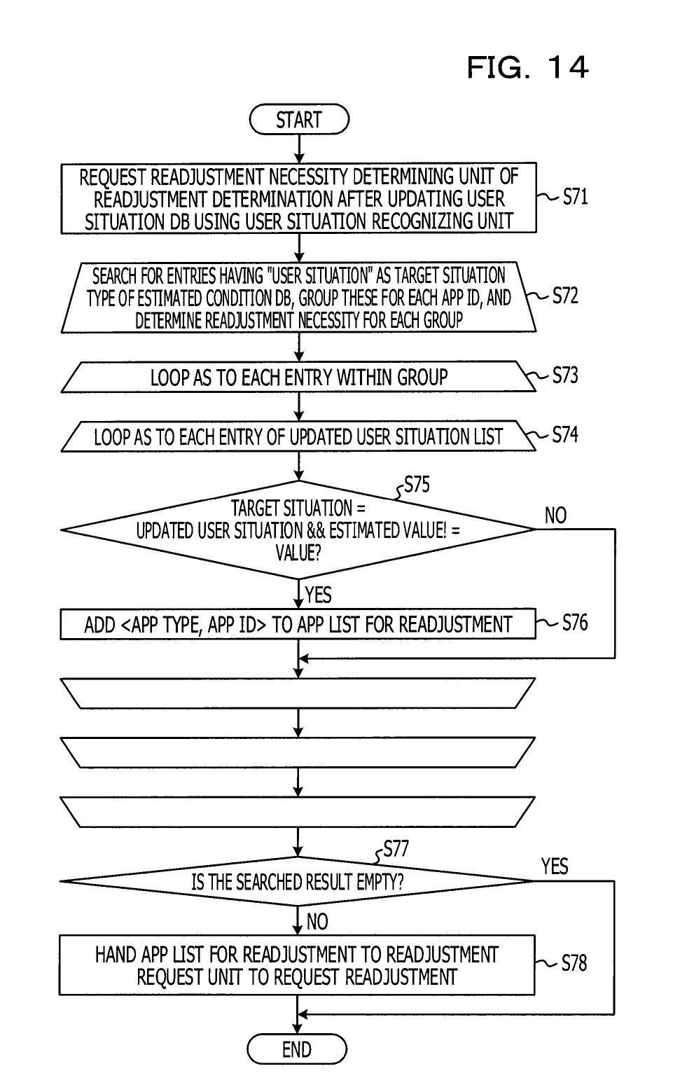

FIG. 14 is a first flowchart illustrating an example of the readjustment necessity determination processing. Note that, with the example in FIG. 14, an example of the readjustment necessity determination processing at the time of change in the user situation.

The readjustment necessity determination processing illustrated in the example in FIG. 14 causes the user situation recognizing unit 65 to request the readjustment necessity determination unit 68 of readjustment determination after updating the user situation DB illustrated in FIG. 8A described above (S71). Note that, with the processing in S71, the readjustment necessity determination processing outputs a list including, for example, “updated user situation, value” to the readjustment necessity determining unit 68. Specific examples of “updated user situation: value” include “<updated user situation> in-company/out-of-company situation, <value> in-company”, and “<updated user situation> situation of traveling on train, <value> No” though not restricted to these.

Next, the readjustment necessity determination processing searches for entries having “user situation” as the target situation type of the estimated condition DB, groups these for each app ID, and determines readjustment necessity for each group (S72). Specifically, the readjustment necessity determination processing performs, as illustrated in FIG. 14, loop processing in S74 to S76 on the entries within a group (e.g., app type, app ID, target situation, estimated value) (S73). Also, the readjustment necessity determination processing performs loop processing in S75 and S76 on the entries (e.g., updated user situation, value) of the updated user situation list (S74).

The readjustment necessity determination processing determines whether or not the target situation agrees with the updated user situation, and also the estimated value does not agrees with the value of the updated user situation (S75), and in the event that the above conditions are satisfied (YES in S75), adds the app type and app ID to the app list for readjustment (S76). Also, in the event that the conditions in S75 are not satisfied (NO in S75), the readjustment necessity determination processing performs nothing.

Next, the readjustment necessity determination processing determines, after end of the loop processing in the processing in S72 to S74, whether or not the search result is empty (S77), and in the event that the search result is not empty (NO in S77), hands the app list for readjustment to the readjustment request unit 69 to request readjustment (S78). Also, in the event that the search result is empty (YES in S77), the readjustment necessity determination processing determines that readjustment does not have to be performed, and is ended as it is.

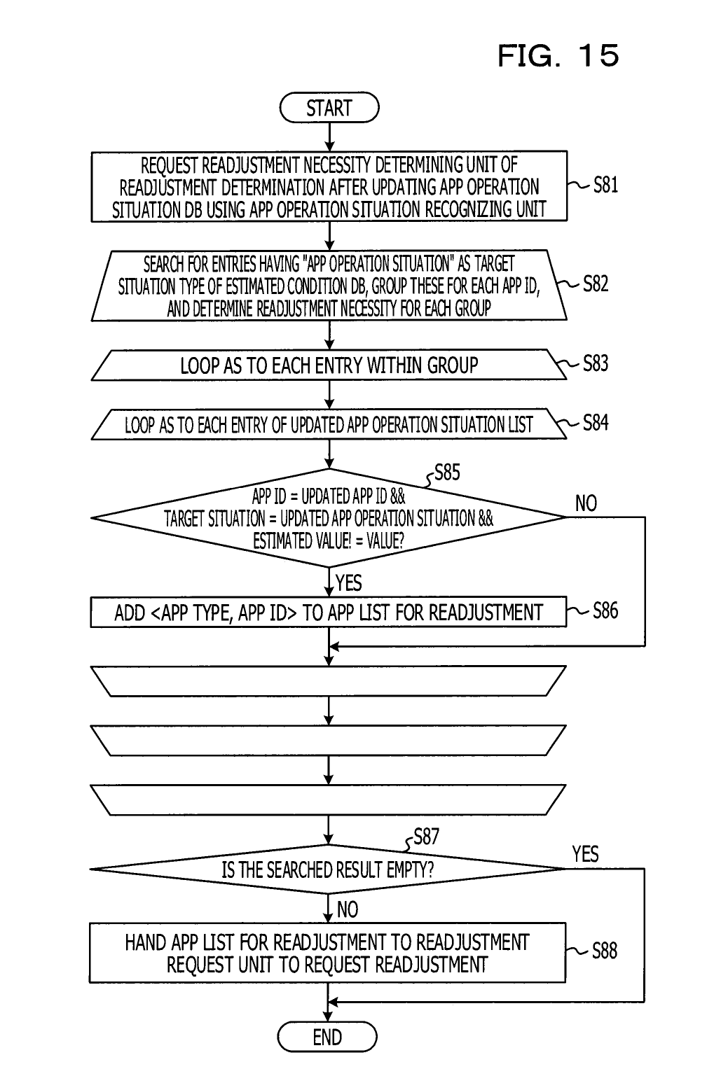

FIG. 15 is a second flowchart illustrating an example of the readjustment necessity processing. Note that the example in FIG. 15 illustrates an example of the readjustment necessity processing at the time of change in the app operation situation.

The readjustment necessity determination processing illustrated in the example in FIG. 15 causes the app operation situation recognizing unit 67 to request the readjustment necessity determining unit 68 of readjustment determination after updating the app operation situation DB illustrated in FIG. 8E (S81). Note that the processing in S81 outputs a list including, for example, “updated app ID, updated app operation situation, value” to the readjustment necessity determining unit 68. Specific examples of “updated app ID, updated app operation situation, value” include “<updated app ID> enquete-20120726194301: <updated app operation situation> non-use period: <value> less than one week”, and “<updated app ID> traveling expenses approval-20121119160801: <updated app operation situation> non-use period: <value> less than three days” though not restricted to these.

Next, the readjustment necessity determination processing searches for entries having “app operation situation” as the target situation type of the estimated condition DB, groups these for each app ID, and determines readjustment necessity for each group (S82). Specifically, the readjustment necessity determination processing performs, as illustrated in FIG. 15, loop processing in S84 to S86 on the entries within a group (e.g., app type, app ID, target situation, estimated value) (S83). Also, the readjustment necessity determination processing performs loop processing in S85 and S86 on the entries (updated app ID, updated app operation situation, value) of the updated user situation list (S84).

The readjustment necessity determination processing determines whether or not the app ID agrees with the updated app ID, the target situation agrees with the updated app operation situation, and the estimated value does not agrees with the value of the updated app operation situation (S85), and in the event that the above conditions are satisfied (YES in S85), adds the app type and app ID to the app list for readjustment (S86). Also, in the event that the conditions in S85 are not satisfied (NO in S85), the readjustment necessity determination processing performs nothing.

Next, the readjustment necessity determination processing determines, after end of the loop processing in the processing in S82 to S84, whether or not the search result is empty (S87), and in the event that the search result is not empty (NO in S87), hands the app list for readjustment to the readjustment request unit 69 to request readjustment (S88). Also, in the event that the search result is empty (YES in S87), the readjustment necessity determination processing determines that readjustment does not have to be performed, and is ended as it is. Note that the above processing in FIGS. 14 and 15 may also be processed by being combined as appropriate.

User Situation DB Updating Processing

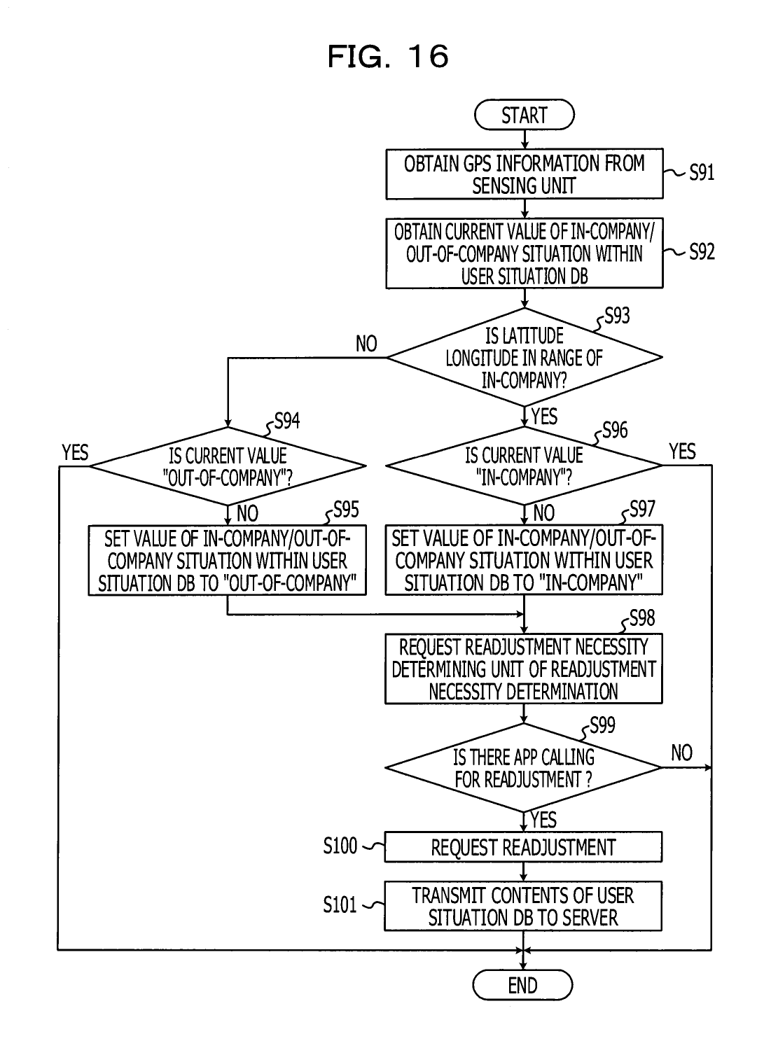

Next, the updating processing of the user situation DB at the user situation recognizing unit 65 as an example of the application execution processing will specifically be described with reference to the flowchart. FIG. 16 is a first flowchart illustrating an example of the updating processing of the user situation DB.

The updating processing of the user situation DB illustrated in the example in FIG. 16 causes the user situation recognizing unit 65 to obtain position information such as latitude longitude or the like as GPS information from the sensing unit 64 (S91). Next, the updating processing obtains the current value (hereinafter, referred to as “current value”) of the in-company/out-of-company situation within the user situation DB (S92).

Now, the updating processing of the user situation DB determines whether or not the latitude longitude obtained in the processing in S91 is in a range of in-company (S93). In the event that the latitude longitude is not in-company (NO in S93), the updating processing determines whether or not the current value obtained in the processing in S92 is “out-of-company” (S94), and in the event of other than “out-of-company” (NO in S94), sets the value of the in-company/out-of-company situation within the user situation DB to “out-of-company” (S95).

Also, in the event that the latitude longitude is in-company in the processing in S93 (YES in S93), the updating processing determines whether or not the current value is “in-company” (S96), and in the event of other than “in-company” (NO in S96), sets the value of the in-company/out-of-company situation within the user situation DB to “in-company” (S97). That is to say, the processes in S95 and S97 perform updating of the DB in the event that the value has been changed.

Next, the updating processing requests the readjustment necessity determining unit 68 of readjustment necessity determination after end of the processing in S95 or S97 (S98) to determine whether or not there is an app calling for readjustment (S99). In the event that there is an app calling for readjustment (YES in S99), the updating processing requests the readjustment request unit 69 of readjustment (S100), and the readjustment request unit 69 transmits the user situation DB and so forth to the application providing server 11 (S101). Thus, the readjustment accepting unit 28 of the application providing server 11 stores the contents of the user situation DB of the data transmitted from a communication terminal 12 in the storage unit 23. Note that, in the event that the current value is out-of-company in the above processing in S94 (YES in S94), in the event that the present is in-company in the processing in S96 (YES in S96), or in the event that there is no app calling for readjustment in the processing in S99 (NO in S99), the updating processing is ended as it is.

Note that the user situation recognizing unit 65 performs the above updating processing at a predetermined timing, whereby the user situation may suitably be recognized. Note that the updating conditions are not restricted to the above example, and the user situation DB may be updated as to a predetermined target situation alone with reference to the estimated situation DB illustrated in FIG. 7B, for example.

Specifically, there is obtained a list of the value of a target situation of which the target situation type item is “user situation” within the estimated situation DB. With the example in FIG. 7B, two types of data of “the target situation is in-company/out-of-company situation, and the estimated value is out-of-company”, and “the target situation is time zone, and the estimated value is 17:00 to 17:59” are obtained as a list. In this case, the updating processing is, as illustrated in FIG. 16, performed on each situation of the list of target situations. Thus, processing for updating the user situation DB is performed on a predetermined target situation alone, and accordingly, battery consumption may be reduced.

Also, with the above user situation DB updating processing, updating processing may be performed by adding schedule information as a user situation. That is to say, the updating processing of the user situation DB is performed by combining schedule contents such as past history and future action schedule and so forth. For example, a schedule is added as the user situation of the app in-use situation correlation DB, and updating processing by the use situation updating unit 29 is added.

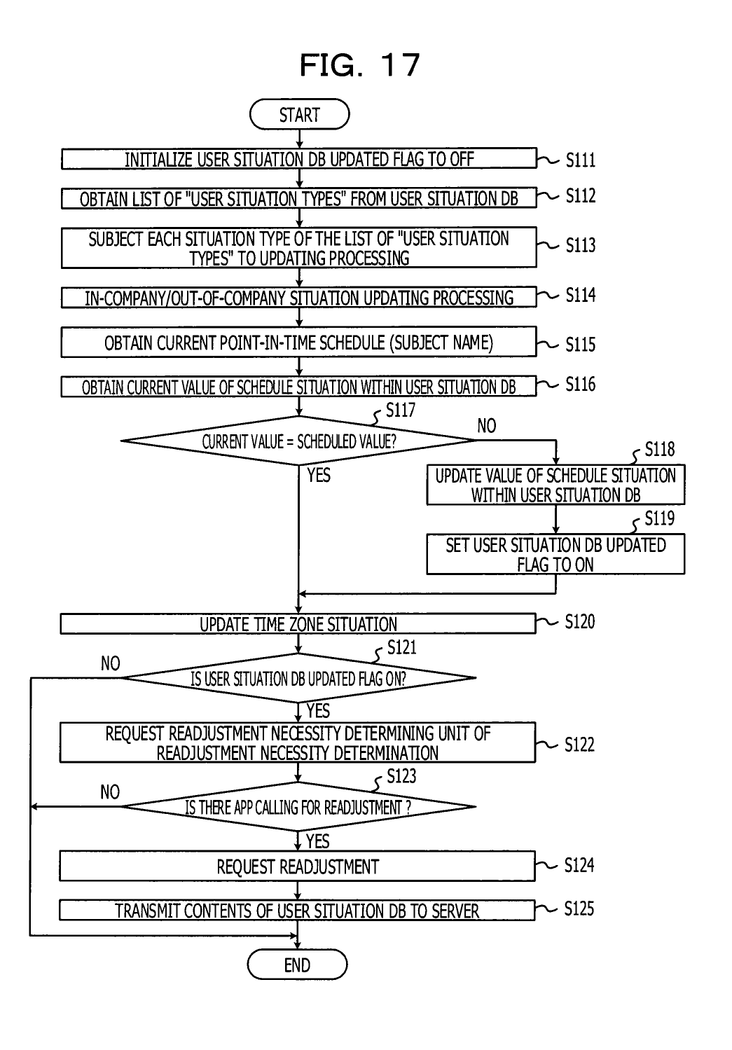

FIG. 17 is a second flowchart illustrating an example of the updating processing of the user situation DB. The updating processing of the user situation DB illustrated in the example in FIG. 17 first initializes a user situation DB updated flag stored in a storage unit or the like to off (S111), and obtains a list of “user situation type” from the user situation DB (S112). Next, the updating processing of the user situation DB performs updating processing on each situation type of the list of “user situation type” (S113).

First, the updating processing of the user situation DB performs updating processing of the in-company/out-of-company situation (S114). As this processing, the above processing in S91 to S97 in FIG. 16 may be used. Also, in the event of having executed the above processing in S95 and S97, the processing in S114 sets the user situation DB updated flag to on.

Next, the updating processing obtains the value of “subject” of the schedule at the current point-in-time from the application providing server 11 (S115), and obtains the current value of the schedule situation within the user situation DB (S116). Now, the updating processing determines whether or not the current value agrees with the schedule (S117), and in the event that the current value does not agree with the schedule (NO in S117), updates the value of the schedule prediction situation within the user situation DB (S118). That is to say, the processing in S117 performs updating of the DB in the event that the value has been changed. Also, the updating processing sets the user situation DB updated flag to on after the processing in S118.

Also, in the event that after end of the processing in S119, the current value agrees with the schedule value in the processing in S117 (YES in S117), the updating processing performs updating of the time zone situation (S120). In the processing in S120, for example, the current value of the time zone situation within the user situation DB is obtained, and in the event that the current value does not agree with the current time, the updating processing updates the value of the time zone situation within the user situation DB, and sets the user situation DB updated flag to on.

Now, the updating processing determines whether or not the user situation DB updated flag is on (S121), and in the event that the user situation DB updated flag is on (YES in S121), the updating processing requests the readjustment necessity determining unit of readjustment necessity determination (S122).

Also, the updating processing determines whether or not there is an app calling for readjustment (S123), and in the event that there is an app calling for readjustment (YES in S123), the updating processing requests the readjustment request unit 69 of readjustment (S124). Also, the readjustment request unit 69 transmits the contents of the user situation DB and so forth to the application providing server 11 (S125). Also, in the event that the user situation DB updated flag is not on in the above processing in S121 (NO in S121), and in the event that there is no app calling for readjustment in the processing in S123 (NO in S123), the updating processing is ended.

App Operation Situation Updating Processing

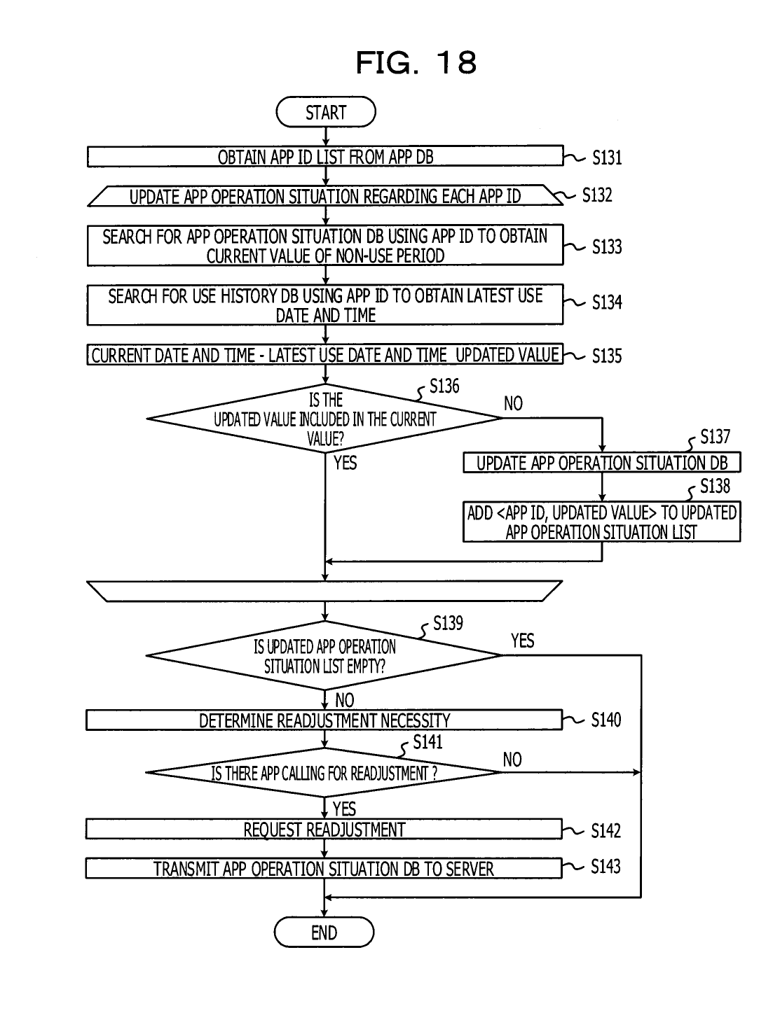

Next, the app operation situation updating processing at the app operation situation recognizing unit 67 as an example of the application execution processing will specifically be described with reference to the flowchart. FIG. 18 is a flowchart illustrating an example of the app operation situation updating processing.

The app operation situation updating processing illustrated in the example in FIG. 18 obtains an app ID list from the app DB such as illustrated in FIG. 8C described above (S131), and updates the app operation situation as to each app ID (S132). Note that the processing in S132 performs loop processing regarding processing in later-described S133 to S138 until the processing as to each app ID is ended.

Specifically, the app operation situation updating processing searches for the app operation situation DB using an app ID to obtain the current value of the non-use period (S133). Next, the app operation situation updating processing searches for the use history DB using an app ID to obtain the latest use date and time (last use date and time) (S134). Now, the app operation situation updating processing takes a value obtained by subtracting the last use date and time from the current date and time as an updated value (S135), and determines whether or not the updated value is included in the current value (S136).

Now, in the event that the updated value is not included in the current value (e.g., less than one week) (NO in S136), the app operation situation updating processing updates the app operation situation DB (S137), and adds the app ID and updated value to the updated app operation situation list (S138). Also, in the event that the updated value is included in the current value in the processing in S136 (YES in S136), the app operation situation updating processing performs nothing. That is to say, the app operation situation updating processing performs updating of the DB only in the event that the value has been changed.

Next, the app operation situation updating processing determines whether or not the updated app operation situation list is empty (S139), and in the event that the updated app operation situation list is not empty (NO in S139), causes the readjustment necessity determining unit 68 to perform readjustment necessity determination (S140). Also, the app operation situation updating processing determines whether or not there is an app calling for readjustment (S141), and in the event that there is an app calling for readjustment (YES in S141), causes the readjustment request unit 69 to perform readjustment request (S142). Thereafter, the app operation situation updating processing causes the readjustment request unit 69 to transmit the contents of the app operation situation DB to the application providing server 11 (S143). Thus, the readjustment accepting unit 28 of the application providing server 11 may store the contents of the app operation situation DB of the received data in the app operation situation DB.

Also, in the event that the updated app operation situation list is empty in the processing in S139 (YES in S139), or in the event that there is no app calling for readjustment in the processing in S141 (NO in S141), the app operation situation updating processing is ended without performing any processing.

### Providing Example of App to be Applied in Present Embodiment

### Adjustment when Situation Changes

Next, a providing example of an app to be applied in the present embodiment will specifically be described. Examples of a terminal app to be provided in the present embodiment include a proposed approval app for a boss approving a proposal from his/her subordinate. This terminal app executes an adjustment processing script for performing adjustment to blur information for internal use only when a user goes outside.

Also, as an example of another terminal app, in the event that a questionnaire entry app (investigation entry app) has not been filled out for a while, adjustment is made so as to change the app thereof to an app with only significant items. In this case, there is executed a script to perform adjustment so as to display an app with fewer contents than questionnaire items displayed on the screen last time. Thus, the screen is simplified, thereby enabling the user to readily reply to the questionnaire.

Also, as another example, with an e-Learning app, there is executed an adjustment processing script which skips, when a user goes outside a company, a portion including information for internal use only, and displays the skipped portion alone when the user returns in the company again. In this case, referenced items are stored as data in the middle of input, whereby an app may be generated regarding items other than the referenced items at the time of app adjustment at the application providing server 11.

Also, with the present embodiment, based on a schedule or the like, an app to apply for balancing account for a business trip when a user returns from the business trip may be distributed (pushed) from the application providing server 11 to the communication terminal 12. This app may also perform balancing account for each business trip, and in the event that the next business trip continues, may also be adjusted so as to include the next business trip.

Specifically, according to the present embodiment, a terminal app is adjusted in a format wherein multiple business trip balancing accounts are available with one request, and accordingly, a boss's number of transactions may be reduced. Also, an arrangement may be made wherein a business trip report app is pushed at the time of approaching a business trip destination (the same with a business meeting minutes app), and when exiting from the business trip destination, start and time point-in-time and participants (user information) are automatically input. Further, an arrangement may be made wherein association with an updated or referenced file is performed during a business trip period, and this is referable at the time of filling out a report. Note that the type of a terminal app is not restricted to this.

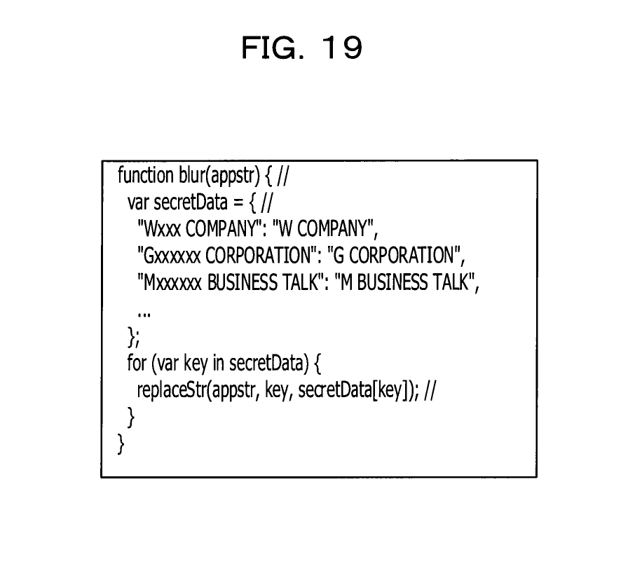

Now, FIG. 19 is a diagram illustrating an example of a adjustment processing script. With the example in FIG. 19, as adjustment processing of app contents, adjustment for blurring information for internal use only is performed based on the position of a communication terminal 12, a user situation, and so forth.

With the present embodiment, as illustrated in FIG. 19, a script is set beforehand for performing adjustment to change information for internal use only (e.g., “Wxxx company”, “Gxxxxxx corporation”, and “Mxxxxxx business talk”) into predetermined words (e.g., a to “W company”, “G corporation”, “M business talk”, or the like).

The user situation recognizing unit 65 of the communication terminals 12 periodically obtain GPS information from the sensing unit 64, and determines whether the user is in the company or outside the company depending on whether or not the latitude longitude is included in a predetermined in-company range. This determination result is stored in the user situation DB illustrated in FIG. 8A described above, and also the user situation DB is transmitted to the application providing server 11.

Now, at the application providing server 11, for example, according to a distribution rule for an executive A, a method for “obtaining an approval” is called up. Examples of arguments at this time include “title”: “Mxxxxxx business talk”, “content”: “ . . . ”.

The app generating unit 26 of the application providing server 11 generates a terminal app based on the above arguments. Also, the app generating unit 26 calls up the in-use situation prediction unit 41-1 to obtain a predicted in-use situation. The contents adjustment unit 41-2 adjusts the terminal app generated at the app generating unit 26 based on the predicted in-use situation and current situation handed by the arguments.

Note that, at the time of adjustment, the contents adjustment unit 41-2 obtains the current situation list from the user situation DB and app operation situation DB, and creates all combinations of the predicted in-use situation (list) and current situation (list) handed by the arguments. Also, in the event that <set of the predicted situation and current situation> of each entry within the situation and adjustment correspondence DB is included in all of the combinations, the contents adjustment unit 41-2 obtains an adjustment processing script of the corresponding entry, and applies the adjustment processing script.

Also, the contents adjustment unit 41-2 performs loop processing as to each entry within the situation and adjustment correspondence DB to obtain an adjustment processing script “blurring information for internal use only” of an entry of which the predicted situation and current situation are included in all of the combinations of the predicted situation list and current situation list. Accordingly, the contents adjustment unit 41-2 applies “blurring information for internal use only” such as illustrated in FIG. 19 as adjustment processing to the generated terminal app.

The app generating unit 26 hands the adjusted terminal app to the app distribution unit 27 to distribute to the executive A's terminal.

Also, the “blurring information for internal use only” adjustment processing script illustrated in FIG. 19 first performs determination of information for internal use only. For example, the adjustment processing script performs string search within the terminal app regarding each name string of personal name and company name list data. As search results, “Wxxx Company”, “Gxxxxxx Corporation”, “Mxxxxxx business talk”, and so forth have been extracted. Next, the adjustment processing script illustrated in FIG. 19 blurs the information for internal use only in a format that avoids others from understanding. Specifically, the adjustment processing script replaces a personal name or company name with the corresponding alternate string (in the example in FIG. 19, “Wxxx Company”→“W Company”, “Gxxxxxx Corporation”→“G Corporation”, “Mxxxxxx business talk”→“M business talk”, etc.).

Accordingly, in the event that the current position of the communication terminal 12 is outside the company, information to be displayed on the screen by this adjustment processing script is changed, whereby leakage of information for internal use only may be avoided. Such a script as illustrated in FIG. 19 may be stored in a storage unit or the like beforehand, for example, as a JavaScript function.

As described above, the present embodiment may run a suitable application adapted to the situation of a communication terminal into an available state. Specifically, a server which generates a terminal app may generate and distribute (push) an app based on a predicted future user situation. That is to say, past app operation history and future user's action schedule are referenced, whereby an app generating method may be determined according to the reference results.

Also, instead of generating or adjusting a terminal app in accordance with the user's current situation, a situation at the time of the user using a terminal app is predicted, and the app is generated and adjusted in accordance therewith, and is pushed to the communication terminal 12. Note that, as an exception, in the event that the user is now outside the company, and is predicted to use the app after returning to the company, information for internal use only is not included. Alternatively, this may be pushed at time of returning to the company. Note that, with the present embodiment, for example, according to the contents of data to be displayed by the terminal app, timing to push information for internal use only may be adjusted.

Also, with the present embodiment, the server side may perform prediction by learning from a user situation at the time of use of an app in the past. For example, according to the past history, in the event that a user who has a business trip from the afternoon frequently uses a terminal app in a business trip destination (approval app for each matter), when a matter occurs during the morning and an app is generated, the user is in the company at the time of generation of an app, but may generate an app for out-of-company.

Also, the server side monitors the user situation after transmission of an app, and reedits the app as appropriate. The server side monitors a user situation such as a terminal position or the like and an app operation situation (in particular, at the time of unanswered) after transmission to a terminal, and may determine change necessity of an app according to the monitoring results. Also, in the event that the user situation has been changed after pushing of a terminal app, the server side performs regeneration or repush of the app. Also, regeneration or repush may also be performed at the time of situation change used for regeneration.

Note that as another variation, difference data alone may be transferred instead of regeneration, for example. Specifically, a terminal app may be divided and distributed in accordance with the user situation or app operation situation. For example, an arrangement may be made wherein a terminal app is divided into questionnaire significant input items and additional input items, and the terminal app is regenerated as to each thereof. Also, with the present embodiment, a terminal app may be divided into an app in which information for internal use only that is workable within the company is included, and an app other that this.

Further, the predicted in-use situation and current situation used for adjustment at the time of generation are registered in the readjustment necessity determining unit of a communication terminal 12 as estimated states, whereby readjustment may be determined to be desirable in the event of being shifted from the estimated situation.

Also, with the present embodiment, timing of an app being used is predicted, adjustment is performed on the app beforehand in accordance with the predicted situation, whereby battery consumption may be suppressed. For example, in the event of performing adjustment such that input history is embedded in the app at the time of adjustment, or the like, it is better to perform adjustment immediately before timing of an app being used.

Accordingly, by applying the present embodiment, a user is able to immediately use an app adapted to the current situation at the time of using the app. Also, even when change in the situation is intense, communication cost and battery consumption may be reduced by suppressing wasteful adjustment processing and terminal app transfer. Also, information for internal use only is not held within the terminal while the user is outside the company, information leakage may be avoided. Also, in the event that the user is in the company, information for internal use only is held in the terminal, and accordingly, transfer latency time at the time of start of use is deleted.

Also, even with the same method call-up from the distribution rule over the server, the system adjusts the terminal app contents in accordance with the user situation, whereby development of operation in accordance with the user situation may readily be performed.

Though the present embodiment has been described in detail, the present technology is not restricted to a particular embodiment, and various modifications and alterations may be made without departing from the scope in claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing system comprising:
a processor configured to:
predict an in-use situation of a communication terminal at a time of use of an application executed on the communication terminal, and
prepare adjusted content of at least a portion of the application based on an in-use situation of the communication terminal as predicted by the circuitry.

2. The information processing system according to claim 1, wherein
the information processing system being a single device.

3. The information processing system according to claim 1, wherein the processor including processing circuitry.

4. The information processing system according to claim 1, further comprising:
an interface that receives from the communication terminal an indication of the in-use situation of the communication terminal.

5. The information processing system according to claim 1, further comprising:
an interface through which the processor distributes the adjusted content to the communication terminal so the communication terminal can execute the application with the adjusted content of the at least a portion of the application.

6. The information processing system according to claim 5, wherein
the processor is configured to
prepare further adjusted content of the application based on an updated in-use situation.

7. The information processing system according to claim 4, wherein
the adjusted content includes information to be displayed on a screen of the communication terminal based on the situation of the communications terminal, the information corresponding to an execution result of the application.

8. The information processing system according to claim 1, wherein
the processor is configured to predict the in-use situation of the communication terminal based on a correlation degree for different situations, the correlation degree being calculated based on respective frequency of use of each of the different situations.

9. The information processing system according to claim 1, wherein
the processor is configured to generate the application when a current in-use situation satisfies a predetermined condition.

10. A communication terminal comprising:
a storage medium configured to hold program instructions of an application; and
a processor coupled to the storage medium and configured to
receive the program instructions of the application from a remote device and store the program instructions in the non-transitory storage medium,
receive from the remote device adjusted content of at least a portion of the application based on a predicted in-use situation of the communications terminal at a time of use of the application.

11. The communication terminal according to claim 10, wherein
the processor including processing circuitry.

12. The communication terminal of claim 10, wherein
the processor provides information of a current use of the communication terminal to the remote device at the time of use of the application.

13. The communication terminal of claim 10, further comprising:
a display, wherein the processor is configured to display information based on the situation of the communication terminal, the information corresponding to an execution result of the application.

14. An application providing method comprising:
predicting using a processor an in-use situation of a communications terminal at a time of use of executed on the communication terminal; and
preparing with the processor adjusted contents of at least a portion of the application based on a predicted in-use situation of the communication terminal.

15. The method according to claim 14, wherein the processor includes processing circuitry.

16. The method of claim 14, further comprising:
receiving from the communication terminal an indication of the in-use situation of the communication terminal.

17. The method of claim 14, further comprising:
distributing the adjusted content to the communication terminal so the communication terminal can execute the application with the adjusted content of the at least a portion of the application.

18. The method of claim 17, further comprising:
preparing further adjusted content of the application based on an updated in-use situation.

19. The method of claim 14, further comprising:
predicting with the processor the in-use situation of the communication terminal based on a correlation degree for different situations, the correlation degree being calculated based on respective frequency of use of each of the different situations.

20. The method of claim 14, further comprising:
generating the application with the processor when a current in-use situation satisfies a predetermined condition.

21. An application execution method comprising:
receiving from a remote device and then storing in a storage medium program instructions of an application;
receiving from the remote device adjusted content of at least a portion of the application based on a predicted in-use situation of the communications terminal at a time of use of the application; and
executing with a processor the application with the adjusted content.

22. The method of claim 21, further comprising:
providing information of a current use of the communication terminal to the remote device at the time of use of the application.

23. A non-transitory computer readable storage medium for storing a program that when executed by a processor causes the processor to execute an application providing process, the process comprising:
predicting, using the processor, an in-use situation of a communications terminal at a time of use of executed on the communication terminal; and
preparing with the processor adjusted contents of at least a portion of the application based on a predicted in-use situation of the communication terminal.

24. A non-transitory computer readable storage medium for storing a program that when executed by a processor causes the processor to execute an application execution process, the process comprising:
receiving from a remote device and then storing in a non-transitory storage medium program instructions of an application;
receiving from the remote device adjusted content of at least a portion of the application based on a predicted in-use situation of the communications terminal at a time of use of the application; and
executing with the processor the application with the adjusted content.
